(19) United States
(12) Patent Application Publication
(10) Pub. No.: US 2026/0161225 A1
(43) Pub. Date: Jun. 11, 2026

(54) POLARIZATION-BASED EYE-TRACKING FOR EXTENDED REALITY WEARABLE SYSTEMS AND DEVICES

(71) Applicant: Meta Platforms Technologies, LLC, Menlo Park, CA (US)

(72) Inventors: Karol Constantine Hatzilias, Sammamish, WA (US); Abhishektha Boppana, Seattle, WA (US); Jixu Chen, Redwood City, CA (US); Woojin Jung, Kenmore, WA (US); Morteza Karami, Redmond, WA (US); Kevin Kha, Cupertino, CA (US); Bennett Ng, San Francisco, CA (US); Walter Nistico, Redwood City, CA (US); Di Xu, Seattle, WA (US); Wei Wu, Bellevue, WA (US)

(21) Appl. No.: 19/402,928

(22) Filed: Nov. 26, 2025

Related U.S. Application Data
(60) Provisional application No. 63/729,263, filed on Dec. 6, 2024.
(60) Provisional application No. 63/786,885, filed on Apr. 10, 2025.

(51) Int. Cl. G06F 3/01; G02B 27/01; H04N 23/90

(52) U.S. Cl. CPC G06F 3/013; G02B 27/017; G02B 27/0179; H04N 23/90; G02B 2027/0178; G02B 2027/0187

(57) ABSTRACT

A head-mounted display system that includes a wearable frame, a lens, one or more display engines, and a polarization-sensitive eye-tracking system is described. The wearable frame includes a first nasal region and a first temporal region. The first lens is mounted in the wearable frame. The first lens defines a first optical axis. The one or more display engines and the eye-tracking system are located on the wearable frame and communicatively coupled to one another. The eye-tracking system includes a first polarization-sensitive camera located in the first nasal region of the wearable frame and a second polarization-sensitive camera located in the first temporal region of the wearable frame.

### TECHNICAL FIELD

This application claims priority to U.S. Provisional Application Ser. No. 63/729,263, filed Dec. 6, 2024, entitled “Eye-Tracking Illumination Sources and Imaging Devices for Extended Reality Wearable Systems and Devices,” and U.S. Provisional Application Ser. No. 63/786,885, filed Apr. 10, 2025, entitled “Polarization-Based Eye-Tracking for Extended Reality Wearable Systems and Devices” each of which is incorporated herein by reference.

### TECHNICAL FIELD

This relates generally to systems and devices for eye-tracking for extended reality wearable systems. In particular, this application relates to eye-tracking based on polarization-sensitive imaging devices, methods, and systems.

### BACKGROUND

Extended reality devices and systems rely upon monitoring, recording, and analyzing eye movements and/or gaze directions of a user. Eye-tracking plays a crucial role in extended reality applications by enabling more natural and immersive interactions. However, accurate eye-tracking for wearable systems remains challenging due to balancing competing constraints, such as object space resolution, population coverages, usage conditions, illumination requirements, prescription lens coexistence, visual occlusions from constrained camera positions, variations in pupil visibility in adverse conditions, complex system design, power, efficiency, cost, and/or component integration issues. Additionally, it remains challenging to achieve satisfactory power efficiencies while providing sufficiently high-resolution image quality within form factor constraints and also reducing conspicuity of optical or mechanical components.

As such, there is a need to address one or more of the above-identified challenges. Below is a brief summary of solutions to the issues noted above.

### SUMMARY

Eye-tracking systems, methods, and devices described herein rely on tracking pupil and/or iris movements of a user's eye. Low and/or no visibility of the pupil and/or iris adversely impacts accuracy and performance of the eye-tracking system, necessitating additional eye-tracking cameras and/or illuminators that increase system cost, complexity, weight, form factor, and conspicuity of the additional components while reducing the wearer's viewing experience and comfort.

In accordance with some embodiments, a head-mounted display system (e.g., an augmented-reality/mixed-reality headset) with an eye-tracking system that reduces conspicuity of optical or mechanical components while providing sufficient image quality and power efficiency is described herein. The head-mounted display system includes a wearable frame (e.g., an eyeglass frame) that includes a first nasal region (e.g., proximate to a nose bridge portion of the frame) and a first temporal region (e.g., proximate to a temporal arm or a hinge for mounting the temporal arm). The head-mounted display system also includes a first lens mounted in the wearable frame, one or more display engines located on the wearable frame, and an eye-tracking system located on the wearable frame and communicatively coupled to the one or more display engines. The first lens defines a first optical axis. The eye-tracking system includes a first camera located in the first nasal region of the wearable frame and a second camera located in the first temporal region of the wearable frame. Each of the first camera and the second camera is characterized by a respective field-of-view (FOV) angle between 60 and 100 degrees.

In some embodiments, each of the first camera and the second camera is characterized by a respective FOV angle between 75 and 85 degrees.

In some embodiments, the first temporal region is located between 10 degrees above the first optical axis and 30 degrees below the first optical axis from a reference point on the first optical axis.

In some embodiments, the reference point is located at a vertex distance (e.g., between 10 and 20 mm, between 12 and 14 mm, etc.) from the first lens.

In some embodiments, each of the first camera and the second camera is mounted at a respective angle so that a camera optical axis of a respective camera points between 20 and 30 degrees below the first optical axis of the first lens.

In some embodiments, the head-mounted display system includes one or more light-emitting-diodes positioned on the wearable frame to provide illumination toward a pupil of a wearer of the head-mounted display system at respective angles so that at least a portion of the illumination is reflected by a retina of the wearer.

In some embodiments, the head-mounted display system includes one or more light-emitting-diodes positioned on the wearable frame to provide illumination toward a cornea of a wearer of the head-mounted display system at respective angles so that at least a portion of the illumination is reflected by a cornea of the wearer.

In some embodiments, the head-mounted display system includes three or more light-emitting-diodes positioned around the wearable frame defining a light-emitting-diode plane. A respective light emitting diode of the three or more light-emitting-diodes is oriented to emit light in a respective direction substantially parallel to the light-emitting-diode plane.

In some embodiments, the wearable frame includes a nose bridge; the first nasal region is located adjacent to the nose bridge, the first temporal region is located away from the nose bridge, and the first nasal region and the first temporal region are mutually exclusive to each other.

In some embodiments, each respective display engine of the one or more display engines includes an image projector.

In some embodiments, the second camera is positioned below a first display engine of the one or more display engines.

In some embodiments, the wearable frame includes a second nasal region that is mutually exclusive to the first nasal region and a second temporal region that is distinct and separate from the first temporal region. The eye-tracking system further includes a third camera located in the second nasal region of the wearable frame, and a fourth camera located in the second temporal region of the wearable frame. In some embodiments, each of the third camera and the fourth camera is characterized by a respective FOV angle between 60 and 100 degrees.

In some embodiments, each of the first camera and the second camera is characterized by a respective FOV angle between 75 degrees and 85 degrees.

In some embodiments, a second lens is mounted in the wearable frame, the second lens defines a second optical axis, and each of the third camera and the fourth camera is mounted at a respective angle so that a camera optical axis of a respective camera points between 20 degrees and 30 degrees below the second optical axis of the second lens.

In accordance with some embodiments, an eye-tracking system for tracking gaze directions of a user includes a frame with a first nasal region and a first temporal region for a first eye of the user, and a second nasal region and a second temporal region for a second eye of the user. A first camera is positioned in the first nasal region, a second camera is positioned in the first temporal region, a third camera is positioned in the second nasal region, and a fourth camera is positioned in the second temporal region. Each of the first camera, the second camera, the third camera, and the fourth camera are characterized by a respective field-of-view (FOV) angle between 60 and 100 degrees.

In accordance with some embodiments, an eye-tracking system includes a frame with a first nasal region and a first temporal region, a first camera located in the first nasal region of the frame, a second camera located in the first temporal region of the frame, and three or more light-emitting-diodes positioned around the frame defining a light-emitting-diode plane. A respective light emitting diode of the three or more light-emitting-diodes is oriented to emit light in a respective direction substantially parallel to the light-emitting-diode plane.

In some embodiments, the respective light emitting diode has a center wavelength of 940 nm.

In some embodiments, a respective optical axis of the respective light emitting diode is substantially parallel to the light-emitting-diode plane.

In some embodiments, the first camera and the second camera are positioned to receive specular reflection of light emitted by the three or more light-emitting-diodes, reflected off a first eye of a user located adjacent to the eye-tracking system.

In some embodiments, the respective light emitting diode of the three or more light-emitting-diodes is configured to emit light within a predefined cone pattern so that at least a portion of the light emitted within the predefined cone pattern impinges on the first eye of the user.

In accordance with some embodiments, a head-mounted display system (e.g., an augmented-reality/mixed-reality headset) with a polarization-sensitive eye-tracking system that improves a visibility of one or more features (e.g., pupil, iris, sclera, etc.) of a wearer's eye(s) is described. The polarization-sensitive camera(s) improves overall eye-tracking accuracy even in challenging conditions while providing simplifications in system design. The head-mounted display system has a wearable frame, a first lens mounted in the wearable frame, one or more display engines located on the wearable frame, and an eye-tracking system with a first polarization-sensitive camera and a second polarization-sensitive camera. The wearable frame includes a first nasal region and a first temporal region. The first lens defines a first optical axis. The first polarization-sensitive camera is located in the first nasal region of the wearable frame and the second polarization-sensitive camera is located in the first temporal region of the wearable frame.

In some embodiments, each of the first polarization-sensitive camera and the second polarization-sensitive camera is positioned to image one or more physical features of an eye of a wearer of the head-mounted display system.

In some embodiments, the one or more physical features of the eye of the wearer of the head-mounted display system are characterized by at least one unique pattern with birefringence.

In some embodiments, each of the first polarization-sensitive camera and the second polarization-sensitive camera is positioned to image one or more sclera features of an eye of a wearer of the head-mounted display system.

In some embodiments, each of the first polarization-sensitive camera and the second polarization-sensitive camera of the head-mounted display system is characterized by a respective field-of-view (FOV) angle between 60 and 100 degrees.

In some embodiments, the first temporal region is located between 10 degrees above the first optical axis and 30 degrees below the first optical axis from a reference point on the first optical axis, and each of the first and the second polarization-sensitive cameras is characterized by a respective field-of-view (FOV) angle between 75 and 85 degrees.

In some embodiments, the reference point is located at a vertex distance from the first lens.

In some embodiments, each of the first polarization-sensitive camera and the second polarization-sensitive camera is mounted at a respective angle so that a camera optical axis of a respective camera points between 20 and 30 degrees below the first optical axis of the first lens.

In some embodiments, one or more light-emitting-diodes are positioned on the wearable frame to provide illumination toward a pupil of a wearer of the head-mounted display system at respective angles so that at least a portion of the illumination is reflected by a retina of the wearer.

In some embodiments, one or more light-emitting-diodes are positioned on the wearable frame to provide illumination toward a cornea of a wearer of the head-mounted display system at respective angles so that at least a portion of the illumination is reflected by a cornea of the wearer.

In some embodiments, three or more light-emitting-diodes are positioned around the wearable frame defining a light-emitting-diode plane, wherein a respective light emitting diode of the three or more light-emitting-diodes is oriented to emit light in a respective direction substantially parallel to the light-emitting-diode plane.

In some embodiments, the wearable frame includes a nose bridge, the first nasal region is located adjacent to the nose bridge, the first temporal region is located away from the nose bridge, and the first nasal region and the first temporal region are mutually exclusive to each other.

In some embodiments, the wearable frame includes a second nasal region that is mutually exclusive to the first nasal region and a second temporal region that is distinct and separate from the first temporal region; the eye-tracking system further includes: a third polarization-sensitive camera located in the second nasal region of the wearable frame; and a fourth polarization-sensitive camera located in the second temporal region of the wearable frame, wherein each of the third polarization-sensitive camera and the fourth polarization-sensitive camera is characterized by a respective FOV angle between 60 and 100 degrees.

In some embodiments, each of the third polarization-sensitive camera and the fourth polarization-sensitive camera is characterized by a respective FOV angle between 75 degrees and 85 degrees.

In some embodiments, a second lens is mounted in the wearable frame, wherein the second lens defines a second optical axis, wherein each of the third polarization-sensitive camera and the fourth polarization-sensitive camera is mounted at a respective angle so that a camera optical axis of a respective polarization-sensitive camera points between 20 degrees and 30 degrees below the second optical axis of the second lens.

In accordance with some embodiments, an eye-tracking system for tracking gaze directions of a user has a frame that includes a first nasal region and a first temporal region for a first eye of the user, and a second nasal region and a second temporal region for a second eye of the user; a first camera positioned in the first nasal region; a second camera positioned in the first temporal region; a third camera positioned in the second nasal region; and a fourth camera positioned in the second temporal region, wherein at least one of the first camera, the second camera, the third camera, and the fourth camera is a polarization-sensitive camera.

In accordance with some embodiments, an eye-tracking system has a frame, a first polarization-sensitive camera, a second polarization-sensitive camera, and three or more light-emitting-diodes positioned around the frame defining a light-emitting-diode plane, wherein a respective light emitting diode of the three or more light-emitting-diodes is oriented to emit light in a respective direction substantially parallel to the light-emitting-diode plane. The frame includes a first nasal region and a first temporal region. The first polarization-sensitive camera is located in the first nasal region of the frame. The second polarization-sensitive camera is located in the second nasal region of the frame.

In some embodiments, the respective light emitting diode has a center wavelength of 940 nm.

In some embodiments, a respective optical axis of the respective light emitting diode is substantially parallel to the light-emitting-diode plane.

In some embodiments, the respective light emitting diode of the three or more light-emitting-diodes is configured to emit light within a predefined cone pattern so that at least a portion of the light emitted within the predefined cone pattern impinges on an eye of a user of the eye-tracking system.

The devices and/or systems described herein can be configured to include instructions that cause the performance of methods and operations associated with the presentation and/or interaction with an extended-reality (XR) headset. These methods and operations can be stored on a non-transitory computer-readable storage medium of a device or a system. It is also noted that the devices and systems described herein can be part of a larger, overarching system that includes multiple devices. A non-exhaustive of list of electronic devices that can, either alone or in combination (e.g., a system), include instructions that cause the performance of methods and operations associated with the presentation and/or interaction with an XR experience includes an extended-reality headset (e.g., a mixed-reality (MR) headset or an augmented-reality (AR) headset as two examples), a wrist-wearable device, an intermediary processing device, a smart textile-based garment, etc. For example, when an XR headset is described, it is understood that the XR headset can be in communication with one or more other devices (e.g., a wrist-wearable device, a server, intermediary processing device) which together can include instructions for performing methods and operations associated with the presentation and/or interaction with an extended-reality system (e.g., the XR headset would be part of a system that includes one or more additional devices). Multiple combinations with different related devices are envisioned, but not recited for brevity.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 is a schematic diagram illustrating an eye-tracking system of a wearable device, in accordance with some embodiments.

FIG. 2 is a schematic diagram illustrating a field-of-view (FOV) of an imaging device of an eye-tracking system, in accordance with some embodiments.

FIG. 3 is a schematic diagram illustrating an FOV of an imaging device of an eye-tracking system, in accordance with some embodiments.

FIGS. 4A-4C are schematic diagrams illustrating different location regions for imaging devices of an eye-tracking system, in accordance with some embodiments.

FIG. 5 is a schematic diagram illustrating a pointing angle of an imaging device of an eye-tracking system, in accordance with some embodiments.

FIG. 6 is a schematic diagram illustrating a cross-sectional view of a wearable device with a side-firing illumination source for eye-tracking, in accordance with some embodiments.

FIGS. 7A, 7B, 7C, and 7D illustrate example MR and AR systems, in accordance with some embodiments.

FIG. 8 illustrates an example head-wearable device, in accordance with some embodiments.

FIG. 9A shows an example camera image of an eye of a wearer of an eye-tracking system, in accordance with some embodiments.

FIG. 9B shows an example polarization-sensitive image of an eye of a wearer of an eye-tracking system, in accordance with some embodiments.

FIG. 10A shows an example polarization-sensitive sensor, in accordance with some embodiments.

FIG. 10B shows an example cross-section of a polarization-sensitive sensor, in accordance with some embodiments.

FIGS. 11A-D show example polarization-sensitive sclera images, in accordance with some embodiments.

FIG. 11E shows an example polarization-sensitive image of an eye of a wearer of an eye-tracking system, in accordance with some embodiments.

FIG. 11F shows an example polarization-sensitive image of an eye of a wearer of an eye-tracking system, in accordance with some embodiments.

FIG. 12A shows an example polarization-sensitive image of an eye, in accordance with some embodiments.

FIG. 12B shows example histogram values for a degree of linear polarization corresponding to sclera regions of the polarization-sensitive image of the eye of FIG. 12A, in accordance with some embodiments.

FIG. 12C shows example intensity variations for a degree of linear polarization corresponding to sclera regions of the polarization-sensitive image of the eye of FIG. 12A, in accordance with some embodiments.

FIG. 13 shows example low resolution eye intensity images and corresponding degree of linear polarization and angle of linear polarization images of an eye, in accordance with some embodiments.

FIGS. 14A and 14B show an example illustration of variations in a confidence score versus the visible area of sclera for a polarization-sensitive image of an eye, in accordance with some embodiments.

FIGS. 15A and 15B show an example illustration of variations in a cumulative displacement for optical flow measurements based on a polarization-sensitive image of the sclera region of an eye, in accordance with some embodiments.

FIGS. 16A and 16B show example gaze error distributions for polarization-enhanced images and intensity-only images, in accordance with some embodiments.

FIGS. 16C and 16D show example illustrations of a polarization-enhanced image with a machine learning model and an intensity-only image with a machine learning model, in accordance with some embodiments.

FIGS. 17A and 17B show example illustrations of sclera pattern matching in polarization-sensitive images of an eye, in accordance with some embodiments.

FIGS. 18A and 18B show example degree of linear polarization eye images and corresponding eye region mask images, in accordance with some embodiments.

FIGS. 18C and 18D show masked degree of linear polarization sclera images and the corresponding images with sclera pattern matching, in accordance with some embodiments.

FIGS. 19A and 19B show an example intensity eye image and a corresponding degree of linear polarization image, in accordance with some embodiments.

FIGS. 19C and 19D show example sclera pattern matching key points for the intensity eye image of FIG. 19A and for the corresponding degree of linear polarization image of FIG. 19B, in accordance with some embodiments.

Various features illustrated in the drawings may not be drawn to scale. Accordingly, the dimensions of the various features may have been expanded or reduced in the drawings for clarity or emphasis. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments described in this application can include or be implemented in conjunction with various types of extended-realities (XRs) such as mixed-reality (MR) and augmented-reality (AR) systems. MRs and ARs, as described herein, are any superimposed functionality and/or sensory-detectable presentation provided by MR and AR systems within a user's physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (e.g., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR headset. Throughout this application, the term “extended reality (XR)” is used as a catchall term to cover both ARs and MRs. In addition, this application also uses, at times, a head-wearable device or headset device as a catchall term that covers XR headsets such as AR headsets and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

As explained above, eye-tracking plays a crucial role in extended reality applications by enabling more natural and immersive interactions. Thus, there is a need for accurate eye-tracking for wearable systems while maintaining power efficiency, providing sufficient high-resolution image quality, satisfying form factor constraints, and reducing conspicuity of various components.

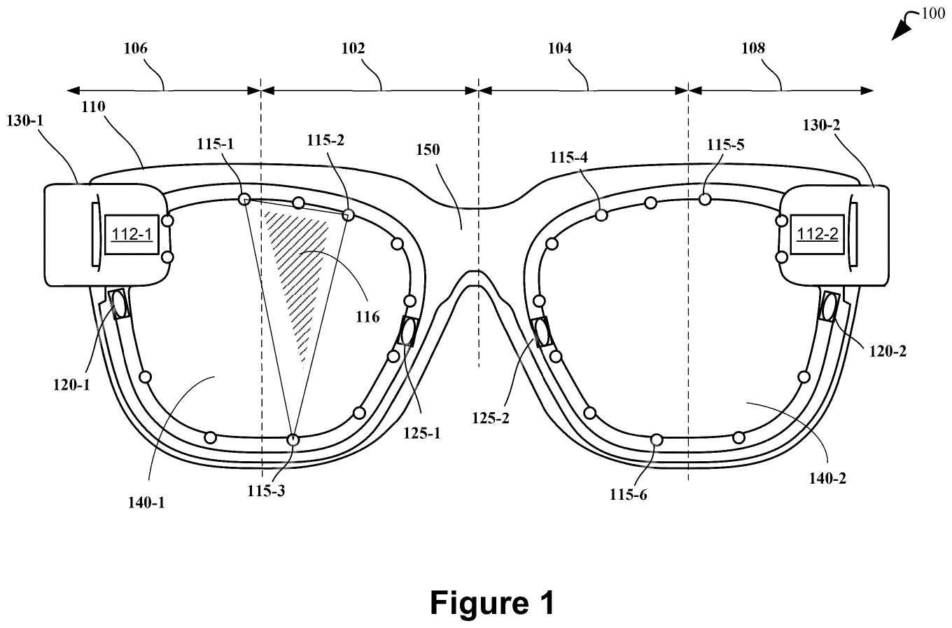

FIG. 1 is a schematic diagram illustrating an eye-tracking system of a wearable device 100, in accordance with some embodiments. In some embodiments, the eye-tracking system includes two or more imaging devices (e.g., cameras 120-1, 120-2, 125-1, and 125-2) and a plurality of illumination sources (e.g., light-emitting-diodes, etc.) positioned on a frame 110 of the wearable device 100. In some embodiments, the plurality of illumination sources is positioned on the frame 110 and defines an illumination-source plane 116 such that a respective optical axis of each illumination source is substantially parallel to the illumination-source plane 116. In some embodiments, the two or more imaging devices are positioned to capture one or more images of at least one eye of a wearer of the wearable device 100. In some embodiments, the wearable device 100 includes one or more display engines (e.g., 130-1 and 130-2) positioned at the outer edges of the frame 110, a first lens 140-1 (e.g., a left lens), and a second lens 140-2 (e.g., a right lens). In some embodiments, the display engines are configured to cause projection of images and/or video frames into an eye of the wearer of the wearable device 100. In some embodiments, the display engines are communicatively coupled to the two or more imaging devices and the plurality of illumination sources.

In some embodiments, the display engine 130-1 includes an image projector 112-1. In some embodiments, the display engine 130-2 includes an image projector 112-2.

In some embodiments, the eye-tracking system includes at least four cameras (e.g., a first temporal camera 120-1, a second temporal camera 120-2, a first nasal camera 125-1, and a second nasal camera 125-2) and a plurality of illumination sources (e.g., 115-1, 115-2, 115-3, 115-4, 115-5, and 115-6) positioned in (or on) the frame 110 of the wearable device 100. In some embodiments, the first temporal camera 120-1 and the second temporal camera 120-2 are positioned on the frame 110 below respective corresponding display engines. In some embodiments, the first temporal camera 120-1 is positioned near a first temple arm of the wearable device 100. In some embodiments, the second temporal camera 120-2 is positioned near a second temple arm of the wearable device 100.

In some embodiments, the first nasal camera 125-1 and the second nasal camera 125-2 are positioned near a nose bridge portion 150 of the frame 110. In some embodiments, each imaging device has a field-of-view angle in the range of 60 degrees to 120 degrees. In some embodiments, each imaging device is characterized by a resolution in the range of 200×200 pixels to 400×400 pixels. In some embodiments, each imaging device is a low power imager.

In some embodiments, the eye-tracking system includes at least sixteen illumination sources positioned on the frame 110 that respectively surround either lens 140-1 or 140-2. For example, the first lens 140-1 is surrounded by at least eight illumination sources (e.g., 115-1, 115-2, 115-3, etc.) that are spaced apart from each other, and the second lens 140-2 is surrounded by at least eight illumination sources (e.g., 115-4, 115-5, 115-6, etc.) that are spaced apart from each other.

In some embodiments, the eye-tracking system includes thirty-two illumination sources positioned on the frame 110 that respectively surround either lens 140-1 or 140-2. For example, the first lens 140-1 is surrounded by sixteen illumination sources (e.g., 115-1, 115-2, 115-3, etc.) that are spaced apart from each other, and the second lens 140-2 is surrounded by sixteen illumination sources (e.g., 115-4, 115-5, 115-6, etc.) that are spaced apart from each other.

In some embodiments, the illumination sources are positioned based on a relative distance to the two or more imaging devices. In some embodiments, the spacing between the illumination sources is based on an angular position of each illumination source with respect to the imaging devices. In some embodiments, the illumination sources are positioned based on a shape and/or size of the frame 110 and the angular position of each illumination source with respect to the imaging devices. In some embodiments, the spacing and/or a total number of illumination sources is constrained by a package size of each illumination source and a size of the frame 110 on which the illumination sources are mounted.

In some embodiments, each illumination source of the plurality of illumination sources is positioned to provide illumination so that at least a portion of the illumination is incident on a respective eye of the wearer. In some embodiments, each illumination source of the plurality of illumination sources is positioned to provide illumination so that at least a portion of the illumination is incident onto a corneal portion of the respective eye of the wearer. In some embodiments, each illumination source of the plurality of illumination sources is positioned to provide illumination so that at least a portion of the illumination is incident onto a retinal portion of the respective eye of the wearer.

In some embodiments, each illumination source of the plurality of illumination sources is positioned to provide illumination so that at least a portion of the illumination that is incident onto a corneal portion and/or a retinal portion of the respective eye of the wearer results in a reflection that is captured by at least one of the two or more imaging devices (e.g., 120-1, 120-2, 125-1, and 125-2). In some embodiments, each illumination source of the plurality of illumination sources is positioned to provide illumination so that at least a portion of the illumination that is incident onto a corneal portion of the respective eye of the wearer results in a specular reflection that is captured by at least one of the two or more imaging devices (e.g., 120-1, 120-2, 125-1, and 125-2).

In some embodiments, the illumination sources are light-emitting-diodes that emit light with wavelengths in the range of 850 nm to 1200 nm. In some embodiments, the light-emitting-diodes have a center wavelength of about 940 nm.

In some embodiments, each lens (e.g., 140-1 or 140-2) of the wearable device 100 includes an optical stack configured to cause display of mixed-reality content, augmented-reality content, or smart glasses content to the wearer of the wearable device 100. In some embodiments, the optical stack includes one or more virtual image distance (VID) layers (e.g., prescription glass layer), an optically clear adhesive layer(s), a display layer, a combiner component, waveguides, grating(s), coupler(s), and/or an anti-reflection layer(s). In some embodiments, the display layer can include a substrate, driver circuitry, and vertical cavity surface emitting lasers (VCSELs).

Although the above-described eye-tracking system is described for a binocular system, alternatively, the wearable device 100 has a monocular eye-tracking system. For example, the monocular eye-tracking system has imaging devices and illumination sources positioned within either a left or a right portion of the wearable device frame 110. For example, the monocular eye-tracking system is configured to either cause display via the left lens 140-1 or the right lens 140-2 by tracking the wearer's gaze for the wearer's left eye or the wearer's right eye.

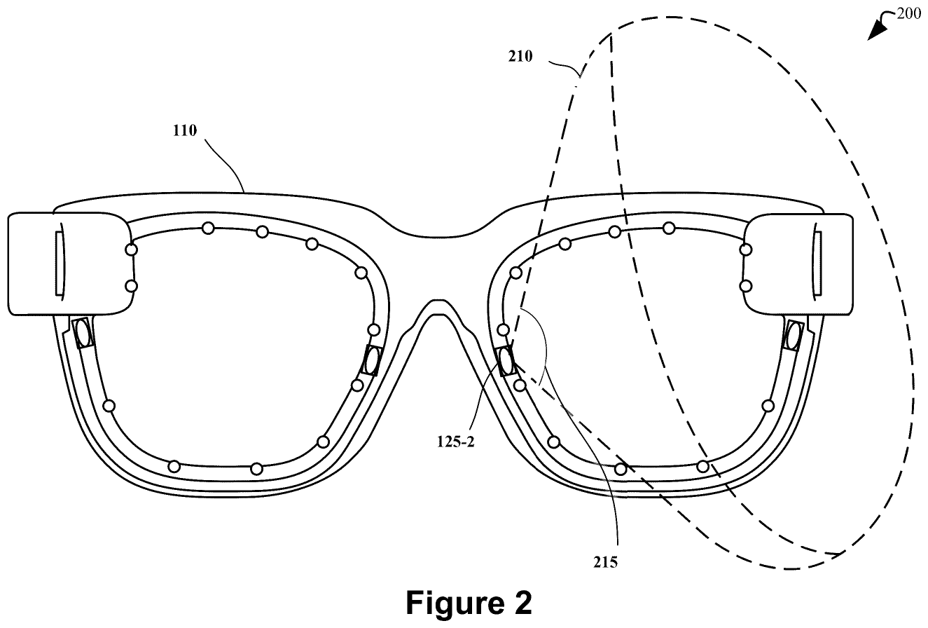

FIG. 2 is a schematic diagram illustrating a field-of-view (FOV) angle 215 of an imaging device (e.g., a nasal camera) of an eye-tracking system, in accordance with some embodiments. In some embodiments, a head-mounted display system includes a wearable device 200 (or wearable device 100 of FIG. 1) with the nasal camera 125-2 as described above with respect to FIG. 1. The nasal camera 125-2 is characterized by an FOV angle 215 that ranges from 60 degrees up to 100 degrees (e.g., the FOV angle 215 is 60 degrees, or 100 degrees, or any angle between 60 and 100 degrees). The FOV angle 215 correlates with a size of an imaging cone 210 for detecting or monitoring the wearer's eye. For example, a lower FOV angle 215 is characterized by a smaller imaging cone size and vice versa.

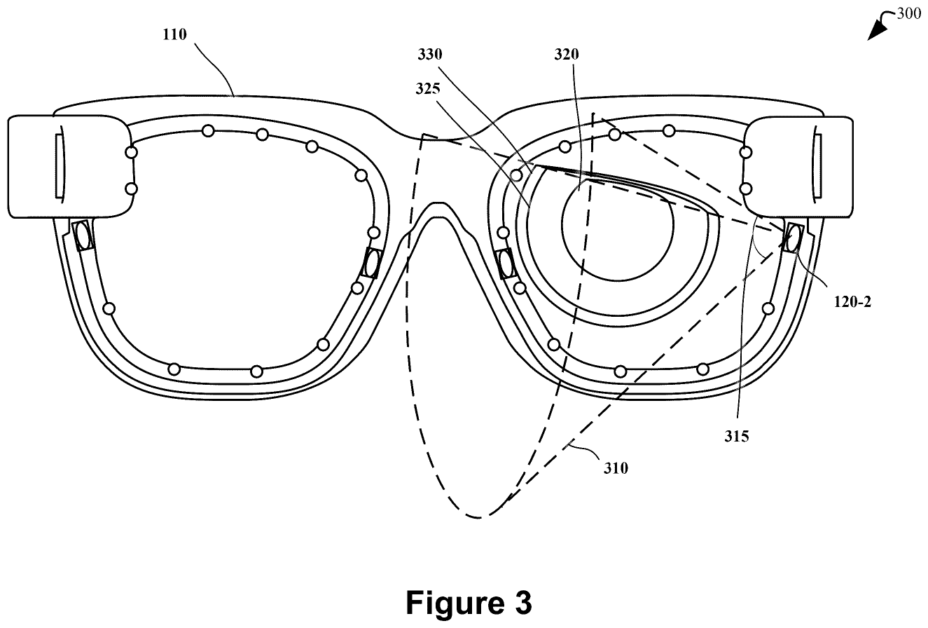

FIG. 3 is a schematic diagram illustrating an FOV angle 315 of an imaging device (e.g., a temporal camera) of an eye-tracking system, in accordance with some embodiments. In some embodiments, a head-mounted display system includes a wearable device 300 (or wearable device 100 of FIG. 1) with the temporal camera 120-2 as described above with respect to FIG. 1. The temporal camera 120-2 is characterized by an FOV angle 315 that ranges from 60 degrees up to 100 degrees (e.g., the FOV angle 315 is 60 degrees, or 100 degrees, or any angle between 60 and 100 degrees). The FOV angle 315 directly correlates with a size of an imaging cone 310 for detecting or monitoring the wearer's eye. For example, a lower FOV angle 315 is characterized by a smaller imaging cone size and vice versa.

In some embodiments, user tests during donning of the head-mounted display system are performed to determine three eye-tracking regions. A first eye-tracking region 320 is characterized by an initial pupil position of a wearer. In some embodiments, the first eye-tracking region 320 extends 3 mm outward from a pupil center to define a circular area 6 mm in diameter. A second eye-tracking region 325 is characterized by iris and cornea offsets. The second eye-tracking region 325 extends 6 mm outward from the pupil center to define a circular area 12 mm in diameter. In some embodiments, the second eye-tracking region 325 is offset by 3 mm with respect to the first eye-tracking region 320. A third eye-tracking region 330 is defined by tolerances related to the physical design of the frame 110 and/or the head-mounted display system. For example, the tolerances are based on donning and/or size variations between different users. In some embodiments, the third eye-tracking region 330 extends 0.5 mm-1 mm outward from the second eye-tracking region 325 to define a circular area that is 13 mm-14 mm in diameter.

In some embodiments, the first eye-tracking region 320, the second eye-tracking region 325, and the third eye-tracking region 330 form concentric circular areas around the pupil center.

In some embodiments, the two or more cameras (120-1, 120-2, 125-1, and 125-2) of the eye-tracking system have a resolution of at least 1 pixel/mm, 2 pixels/mm, 3 pixels/mm, 4 pixels/mm, or 5 pixels/mm. In some embodiments, the two or more cameras (120-1, 120-2, 125-1, and 125-2) of the eye-tracking system have a resolution that is less than or equal to 10 pixels/mm, 8 pixels/mm, 7 pixels/mm, 6 pixels/mm, or 5 pixels/mm.

In some embodiments, an FOV angle of 100 degrees for each of the nasal camera (125-1 or 125-2) and the temporal camera (120-1 or 120-2), for a monocular portion of the eye-tracking system, provides a 100 % population coverage for eye-tracking across a range of functional user tests for the head-mounted display system at a predefined threshold imaging resolution (e.g., 1 pixel/m, 2 pixels/mm, 3 pixels/mm, 4 pixels/mm, 5 pixels/mm, 6 pixels/mm, 7 pixels/mm, 8 pixels/mm, 9 pixels/mm, or 10 pixels/mm or any value between any two of the aforementioned values). The 100% population coverage for the eye-tracking system at the 100-degree FOV angle is reflective of accurately mapping estimated user gaze versus actual user gaze target. In some embodiments, the population coverage for the monocular portion of the eye-tracking system decreases to 79% for an imaging resolution that exceeds the predefined threshold imaging resolution due to lower object space resolution.

In some embodiments, an FOV angle of 90 degrees for each of the nasal camera (125-1 or 125-2) and the temporal camera (120-1 or 120-2), for the monocular portion of the eye-tracking system, provides an 99.9% population coverage for eye-tracking across a range of functional user tests for the head-mounted display system at an imaging resolution of the predefined threshold imaging resolution. The 99.9% population coverage for the eye-tracking system at the 90-degree FOV angle is reflective of still accurately mapping estimated user gaze versus actual user gaze target. In some embodiments, the population coverage for the monocular portion of the eye-tracking system decreases to 80% for an imaging resolution that exceeds the predefined threshold imaging resolution due to lower object space resolution.

In some embodiments, an FOV angle of 80 degrees for each of the nasal camera (125-1 or 125-2) and the temporal camera (120-1 or 120-2), for the monocular portion of the eye-tracking system, provides a 97% population coverage for eye-tracking across a range of functional user tests for the head-mounted display system at an imaging resolution of the predefined threshold imaging resolution. The 97% population coverage for the eye-tracking system at the 80-degree FOV angle is reflective of maintaining high accuracies for mapping estimated user gaze versus actual user gaze target. In some embodiments, the population coverage for the monocular portion of the eye-tracking system decreases to 87% for an imaging resolution that exceeds the predefined threshold imaging resolution due to lower object space resolution that is somewhat counterbalanced by the decrease in the FOV angle as compared to the 100-degree FOV angle. Overall, the 87% population coverage at the 80-degree FOV angle is higher than the 80% population coverage at the 90-degree FOV angle and the 79% population coverage at the 100-degree FOV angle.

In some embodiments, an FOV angle of 70 degrees for each of the nasal camera (125-1 or 125-2) and the temporal camera (120-1 or 120-2), for the monocular portion of the eye-tracking system, provides an 88% population coverage for eye-tracking across a range of functional user tests for the head-mounted display system at an imaging resolution of the predefined threshold imaging resolution. The 88% population coverage for the eye-tracking system at the 70-degree FOV angle is reflective of a significant decrease in accuracy for mapping estimated user gaze versus actual user gaze target. In some embodiments, the population coverage for the monocular portion of the eye-tracking system remains fairly unchanged at 89% for an imaging resolution that exceeds the predefined threshold imaging resolution.

Thus, the 80-degree FOV angle for each of the nasal camera (125-1 or 125-2) and the temporal camera (120-1 or 120-2), for the monocular portion of the eye-tracking system, provides both acceptable population coverages and imaging resolution.

In some embodiments, an FOV angle ranges from 75 degrees to 85 degrees for each of the nasal camera (125-1 or 125-2) and the temporal camera (120-1 or 120-2), for the monocular portion of the eye-tracking system.

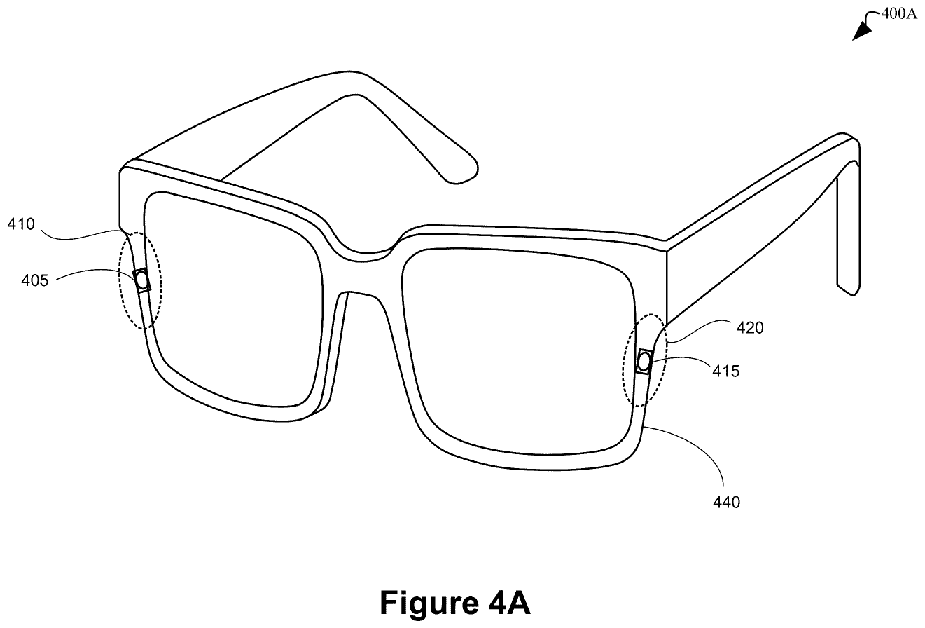

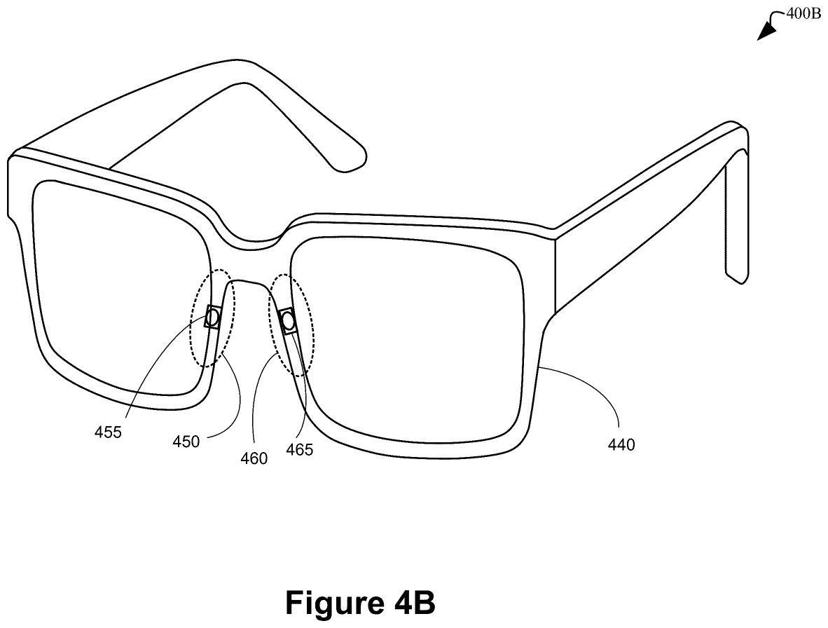

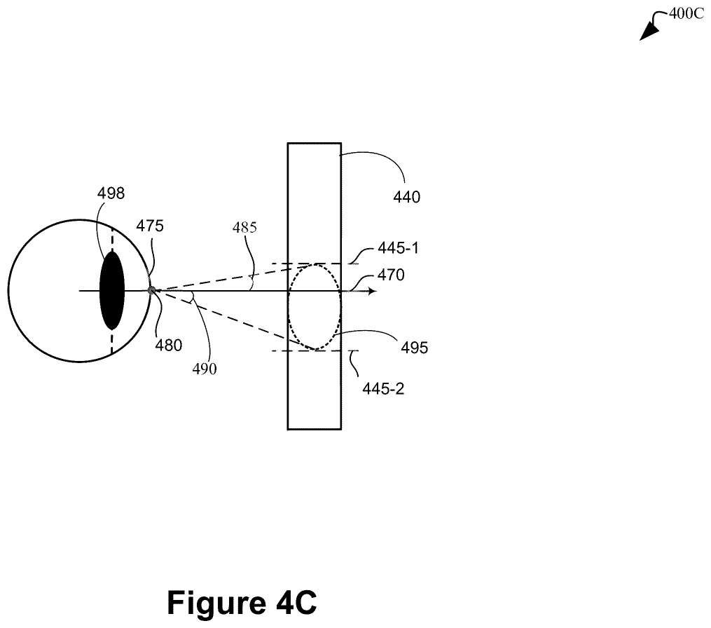

FIGS. 4A-4C are schematic diagrams illustrating different regions for imaging devices of an eye-tracking system, in accordance with some embodiments. FIG. 4A shows temporal regions 410 and 420 that respectively correspond to a location for positioning each of the temporal cameras 405 and 415 on a wearable device frame 440, in accordance with some embodiments. FIG. 4B shows nasal regions 450 and 460 that respectively correspond to a location for positioning each of the nasal cameras 455 and 465, in accordance with some embodiments. In some embodiments, the nasal region (e.g., 450 and 460) encompasses areas for positioning the nasal camera such that the camera is hidden from the wearer's gaze (e.g., under a nose pad).

FIG. 4C shows positioning region 495 for affixing a mechanical center of an imaging device of the eye-tracking system, in accordance with some embodiments. In some embodiments, the region 495 has an upper boundary 445-1 defined by a first angle 485 made with respect to an optical axis 470 of the wearer's eye. In some embodiments, the region 495 has a lower boundary 445-2 defined by a second angle 490 made with respect to an optical axis 470 of the wearer's eye. The optical axis 470 passes through a center 480 of the cornea 475 of the wearer's eye and a center of the pupil 498. In some embodiments, the first angle 485 is less than or equal to 20 degrees, 15 degrees, 10 degrees or 5 degrees, or any value selected between any two of the aforementioned values. In some embodiments, the second angle 490 is less than or equal to 35 degrees, 30 degrees, 25 degrees, 20 degrees, 15 degrees, or 10 degrees, or any value selected between any two of the aforementioned values.

In some embodiments, the mechanical center of the camera (e.g., 405, 415, 455, 465) is positioned on a flexible rim attached to the wearable device frame 440 at a horizontal distance of 4 mm or less from an edge of a respective lens (e.g., 140-1 or 140-2 of FIG. 1) of the wearable device. Alternatively, in some embodiments, the mechanical center of the camera (e.g., 405, 415) is positioned on a rigid unibody frame attached to a deformable wearable device frame 440 at a horizontal distance of 4 mm or less from an edge of a respective lens (e.g., 140-1 or 140-2 of FIG. 1) of the wearable device.

In some embodiments, the eye-tracking system has access to multiple views of the same eye (e.g., by synchronizing image capture across two or more cameras per eye), and center alignment of the two or more imaging devices is determined using a simple model of the eye during motion that enables estimation of a reasonable alignment requirement between the multiple cameras.

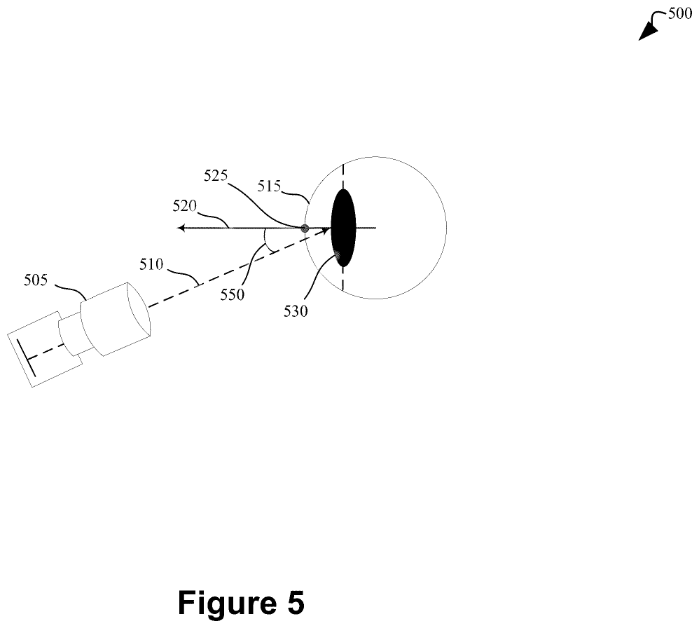

FIG. 5 is a schematic diagram illustrating a pointing angle of an imaging device 505 of an eye-tracking system, in accordance with some embodiments. In some embodiments, the imaging device 505 is a camera as described above with respect to FIGS. 1 through 4C. In some embodiments, the camera points toward the wearer's eye from an angle 550 that is 20 degrees to 30 degrees below an eye level with respect to the pupil's optical axis 520. The pupil's optical axis 520 is defined by a line that passes through a center of the pupil 530 and a corneal center 525 of the wearer's corneal region 515. In some embodiments, the camera's optical axis 510 makes an angle that is 20 degrees to 30 degrees with the pupil's optical axis 520. In some embodiments, the pointing angle of the two or more imaging devices is determined based on maximizing population coverage, accurately predicting eye motion (from gaze), and determining effects of motion of the wearable device (e.g., while donning).

In some embodiments, positioning the temporal camera (e.g., 120-1, 120-2) at a pointing angle that is 20 degrees to 30 degrees below an eye level defined by the pupil's optical axis 520 leads to fitment, visual occlusion, conspicuity, and other adverse wearer experiences. In some embodiments, the temporal camera is positioned below the display engine while satisfying the pointing angle requirements and reducing fitment, wearer visual occlusion, conspicuity, and other adverse wearer experiences. Although some periocular occlusion is caused by positioning the temporal camera below the display engine, a sufficient view of the wearer's eye is obtained as described with respect to FIGS. 2 through 4C for functional and accurate eye-tracking.

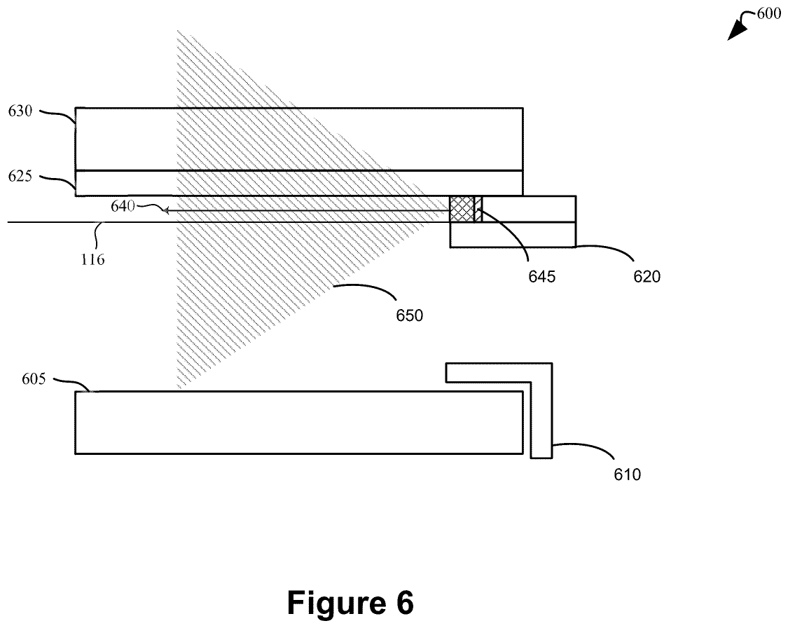

FIG. 6 is a schematic diagram illustrating a cross-sectional view of a wearable device with a side-firing illumination source for eye-tracking, in accordance with some embodiments. In some embodiments, the cross-sectional view of the wearable device includes a cross-sectional view of the illumination source 645 and the optical stack described with respect to FIG. 1. In some embodiments, the illumination source 645 is supported by a substrate and/or supporting component 620. In some embodiments, the optical stack includes the virtual image distance layer 630, the OCA layer 625, the display layer, the combiner, the waveguide layer 605, supporting component 610, and/or one or more substrate layers (e.g., polymers, glass, circuitry, etc.).

In some embodiments, the illumination source 645 is (or includes) a light emitting diode with an optical axis 640. In some embodiments, the light emitting diode is oriented to emit light 650 in a respective direction that is substantially parallel to the plane 116 containing the plurality of light-emitting-diodes of the eye-tracking system as described above with respect to FIG. 1. In some embodiments, at least a portion of the emitted light 650 is incident on the wearer's eye. In some embodiments, at least a portion of the emitted light 650 is incident on, and/or reflected off, the cornea of the wearer's eye. In some embodiments, at least a first portion of the emitted light 650 is incident on the wearer's eye and the first portion of the emitted light 650 undergoes specular reflection. In some embodiments, at least one of the two or more imaging devices captures an image of the specular reflection (e.g., glint) of the at least first portion of the emitted light 650.

In some embodiments, the eye-tracking illuminations from the plurality of illumination sources is synchronized with the two or more imaging devices to optimize power consumption and enhance operating efficiencies. In some embodiments, illumination is turned on shortly after triggering exposure by one of the cameras. In some embodiments, illumination is turned off shortly before exposure by the camera ends. The power can be optimized by finding a balance between power illumination efficiency and exposure time of the camera.

In some embodiments, the specular reflections respectively associated with each of the light-emitting-diodes are used to determine a glint score. In some embodiments, the glint score is calculated using the respective distances of the glints from an optical axis running through the center of the cornea and the pupil center. The higher the glint score, the better the performance of the eye-tracking system. In some embodiments, the higher the glint score, the better the illumination performance metrics of brightness, uniformity, and glint coverage.

In light of these principles, we now turn to certain embodiments.

In accordance with some embodiments, a head-mounted display system (e.g., 100, 200, 300, or 600) with an eye-tracking system is described herein. The head-mounted display system includes a wearable frame (e.g., an eyeglass frame, such as 110, 440) that includes a first nasal region (e.g., 102, 450) and a first temporal region (e.g., 106, 410). The head-mounted system includes a first lens (e.g., 140-1) mounted in the wearable frame, one or more display engines (e.g., 130-1) located on the wearable frame, and an eye-tracking system (e.g., a combination of 120-1 and 125-1) located on the wearable frame and communicatively coupled to the one or more display engines. The first lens (e.g., 140-1) defines a first optical axis (e.g., 470). The eye-tracking system includes a first camera (e.g., 125-1) located in the first nasal region (e.g., 102, 455) of the wearable frame and a second camera (e.g., 120-1) located in the first temporal region (e.g., 106, 410) of the wearable frame. Each of the first camera and the second camera is characterized by a respective field-of-view (FOV) angle between 60 and 100 degrees.

In some embodiments, each of the first camera and the second camera is characterized by a respective FOV angle (e.g., 215 or 315) between 75 and 85 degrees.

In some embodiments, the first temporal region is located between 10 degrees (e.g., 485) above the first optical axis (e.g., 470) and 30 degrees (e.g., 490) below the first optical axis from a reference point (e.g., 480) on the first optical axis. In some embodiments, the first optical axis of the first lens corresponds to an optical axis of an eye of the wearer of the wearable device that passes through a cornea center (e.g., 480) of the eye.

In some embodiments, the reference point (e.g., 480) is located at a vertex distance (e.g., between 10 and 20 mm, between 12 and 14 mm, etc.) from the first lens.

In some embodiments, each of the first camera and the second camera is mounted at a respective angle so that a camera optical axis (e.g., 510) of a respective camera (e.g., 505) points between 20 and 30 degrees (e.g., 550) below the first optical axis 470 (which in some configurations corresponds to the pupil's optical axis 520) of the first lens.

In some embodiments, the head-mounted display system includes one or more light-emitting-diodes (e.g., 115-1, 115-2, 115-3, etc.) positioned on the wearable frame (e.g., 110 or 440) to provide illumination toward a pupil (e.g., 498) of a wearer of the head-mounted display system at respective angles so that at least a portion of the illumination is reflected by a retina of the wearer.

In some embodiments, the head-mounted display system includes one or more light-emitting-diodes (e.g., 115-1, 115-2, 115-3, etc.) positioned on the wearable frame (e.g., 110 or 440) to provide illumination toward a cornea of a wearer of the head-mounted display system at respective angles so that at least a portion of the illumination is reflected by a cornea (e.g., 475 or 515) of the wearer.

In some embodiments, the head-mounted display system includes three or more light-emitting-diodes (e.g., 115-1, 115-2, and 115-3) positioned around the wearable frame defining a light-emitting-diode plane 116. A respective light emitting diode of the three or more light-emitting-diodes is oriented to emit light in a respective direction substantially parallel to the light-emitting-diode plane (e.g., FIG. 6).

In some embodiments, the wearable frame includes a nose bridge (e.g., 150); the first nasal region (e.g., 102) is located adjacent to the nose bridge, the first temporal region (e.g., 106) is located away from the nose bridge, and the first nasal region and the first temporal region are mutually exclusive to each other. In some embodiments, the wearable frame includes the second nasal region (e.g., 104) located adjacent to the nose bridge, the second temporal region (e.g., 108) located away from the nose bridge, and the second nasal region and the second temporal region are mutually exclusive to each other.

In some embodiments, a respective display engine of the one or more display engines includes an image projector (e.g., image projector 112-1 or 112-2).

In some embodiments, the second camera is positioned below a first display engine of the one or more display engines (e.g., FIG. 1).

In some embodiments, the wearable frame includes a second nasal region that is mutually exclusive to the first nasal region and a second temporal region that is distinct and separate from the first temporal region, and the eye-tracking system further includes a third camera located in the second nasal region of the wearable frame, and a fourth camera located in the second temporal region of the wearable frame. In some embodiments, each of the third camera and the fourth camera is characterized by a respective FOV angle between 60 and 100 degrees.

In some embodiments, each of the first camera and the second camera is characterized by a respective FOV angle between 75 degrees and 85 degrees.

In some embodiments, a second lens is mounted in the wearable frame, the second lens defines a second optical axis, and each of the third camera and the fourth camera is mounted at a respective angle so that a camera optical axis of a respective camera points between 20 degrees and 30 degrees below the second optical axis of the second lens.

In accordance with some embodiments, an eye-tracking system for tracking gaze directions of a user includes a frame with a first nasal region and a first temporal region for a first eye of the user, and a second nasal region and a second temporal region for a second eye of the user. A first camera is positioned in the first nasal region, a second camera is positioned in the first temporal region, a third camera is positioned in the second nasal region, and a fourth camera is positioned in the second temporal region. Each of the first camera, the second camera, the third camera, and the fourth camera are characterized by a respective field-of-view (FOV) angle between 60 and 100 degrees.

In accordance with some embodiments, an eye-tracking system includes a frame with a first nasal region and a first temporal region, a first camera located in the first nasal region of the frame, a second camera located in the first temporal region of the frame, and three or more light-emitting-diodes (e.g., 115-1, 115-2, 115-3, etc.) positioned around the frame defining a light-emitting-diode plane. A respective light emitting diode (e.g., 645) of the three or more light-emitting-diodes is oriented to emit light (e.g., 650) in a respective direction (e.g., 640) substantially parallel to the light-emitting-diode plane 116.

In some embodiments, the respective light emitting diode has a center wavelength of 940 nm.

In some embodiments, a respective optical axis (e.g., 640) of the respective light emitting diode (e.g., 645) is substantially parallel to the light-emitting-diode plane 116.

In some embodiments, the first camera and the second camera are positioned to receive specular reflection of light emitted by the three or more light-emitting-diodes, reflected off a first eye of a user located adjacent to the eye-tracking system.

In some embodiments, the respective light emitting diode of the three or more light-emitting-diodes is configured to emit light within a predefined cone pattern so that at least a portion of the light emitted within the predefined cone pattern impinges on the first eye of the user.

### Example Extended-Reality Systems

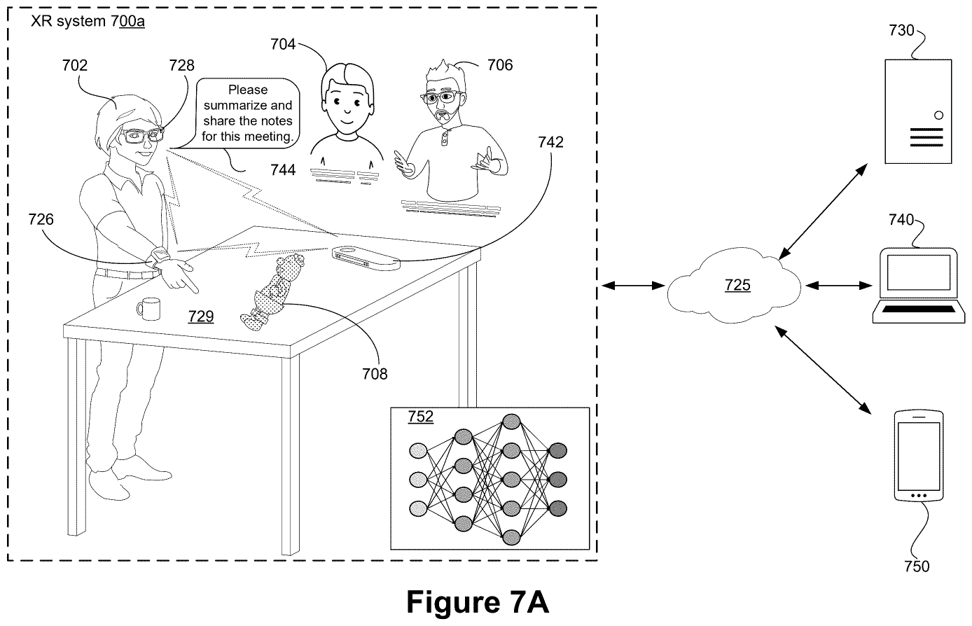

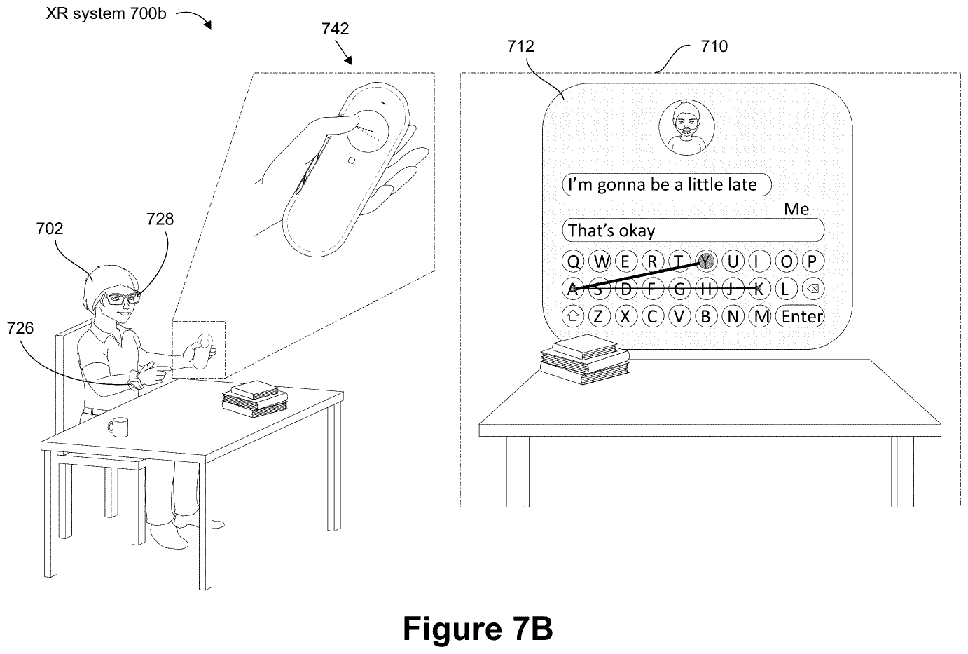

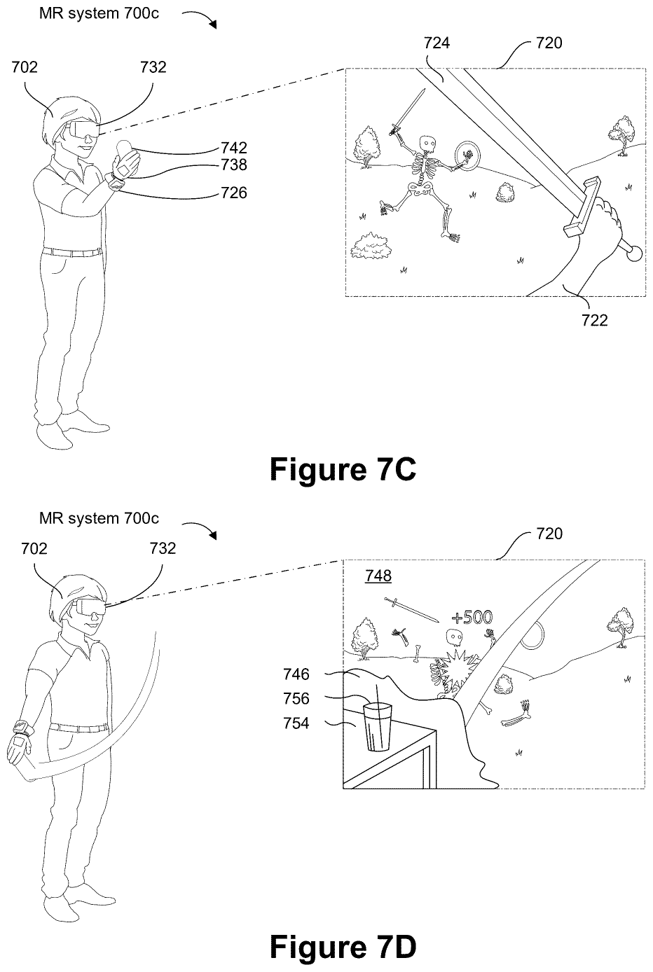

FIGS. 7A, 7B, 7C, and 7D, illustrate example XR systems that include AR and MR systems, in accordance with some embodiments. FIG. 7A shows a first XR system 700a and first example user interactions using a wrist-wearable device 726, a head-wearable device (e.g., AR device 728), and/or a HIPD 742. FIG. 7B shows a second XR system 700b and second example user interactions using a wrist-wearable device 726, AR device 728, and/or an HIPD 742. FIGS. 7C and 7D show a third XR system 700c and third example user interactions using a wrist-wearable device 726, a head-wearable device (e.g., an MR device such as a VR device), and/or an HIPD 742. As the skilled artisan will appreciate upon reading the descriptions provided herein, the above-example AR and MR systems (described in detail below) can perform various functions and/or operations.

The wrist-wearable device 726, the head-wearable devices, and/or the HIPD 742 can communicatively couple via a network 725 (e.g., cellular, near field, Wi-Fi, personal area network, wireless LAN). Additionally, the wrist-wearable device 726, the head-wearable device, and/or the HIPD 742 can also communicatively couple with one or more servers 730, computers 740 (e.g., laptops, computers), mobile devices 750 (e.g., smartphones, tablets), and/or other electronic devices via the network 725 (e.g., cellular, near field, Wi-Fi, personal area network, wireless LAN). Similarly, a smart textile-based garment, when used, can also communicatively couple with the wrist-wearable device 726, the head-wearable device(s), the HIPD 742, the one or more servers 730, the computers 740, the mobile devices 750, and/or other electronic devices via the network 725 to provide inputs.

Turning to FIG. 7A, a user 702 is shown wearing the wrist-wearable device 726 and the AR device 728 and having the HIPD 742 on their desk. The wrist-wearable device 726, the AR device 728, and the HIPD 742 facilitate user interaction with an AR environment. In particular, as shown by the first XR system 700a, the wrist-wearable device 726, the AR device 728, and/or the HIPD 742 cause presentation of one or more avatars 704, digital representations of contacts 706, and virtual objects 708. As discussed below, the user 702 can interact with the one or more avatars 704, digital representations of the contacts 706, and virtual objects 708 via the wrist-wearable device 726, the AR device 728, and/or the HIPD 742. In addition, the user 702 is also able to directly view physical objects in the environment, such as a physical table 729, through transparent lens(es) and waveguide(s) of the AR device 728. Alternatively, an MR device could be used in place of the AR device 728 and a similar user experience can take place, but the user would not be directly viewing physical objects in the environment, such as table 729, and would instead be presented with a virtual reconstruction of the table 729 produced from one or more sensors of the MR device (e.g., an outward facing camera capable of recording the surrounding environment).

The user 702 can use any of the wrist-wearable device 726, the AR device 728 (e.g., through physical inputs at the AR device and/or built-in motion tracking of a user's extremities), a smart-textile garment, externally mounted extremity tracking device, the HIPD 742 to provide user inputs, etc. For example, the user 702 can perform one or more hand gestures that are detected by the wrist-wearable device 726 (e.g., using one or more EMG sensors and/or IMUs built into the wrist-wearable device) and/or AR device 728 (e.g., using one or more image sensors or cameras) to provide a user input. Alternatively, or additionally, the user 702 can provide a user input via one or more touch surfaces of the wrist-wearable device 726, the AR device 728, and/or the HIPD 742, and/or voice commands captured by a microphone of the wrist-wearable device 726, the AR device 728, and/or the HIPD 742. The wrist-wearable device 726, the AR device 728, and/or the HIPD 742 include an artificially intelligent digital assistant to help the user in providing a user input (e.g., completing a sequence of operations, suggesting different operations or commands, providing reminders, confirming a command). For example, the digital assistant can be invoked through an input occurring at the AR device 728 (e.g., via an input at a temple arm of the AR device 728). In some embodiments, the user 702 can provide a user input via one or more facial gestures and/or facial expressions. For example, cameras of the wrist-wearable device 726, the AR device 728, and/or the HIPD 742 can track the user 702's eyes for navigating a user interface.

The wrist-wearable device 726, the AR device 728, and/or the HIPD 742 can operate alone or in conjunction to allow the user 702 to interact with the AR environment. In some embodiments, the HIPD 742 is configured to operate as a central hub or control center for the wrist-wearable device 726, the AR device 728, and/or another communicatively coupled device. For example, the user 702 can provide an input to interact with the AR environment at any of the wrist-wearable device 726, the AR device 728, and/or the HIPD 742, and the HIPD 742 can identify one or more back-end and front-end tasks to cause the performance of the requested interaction and distribute instructions to cause the performance of the one or more back-end and front-end tasks at the wrist-wearable device 726, the AR device 728, and/or the HIPD 742. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 742 can perform the back-end tasks and provide the wrist-wearable device 726 and/or the AR device 728 operational data corresponding to the performed back-end tasks such that the wrist-wearable device 726 and/or the AR device 728 can perform the front-end tasks. In this way, the HIPD 742, which has more computational resources and greater thermal headroom than the wrist-wearable device 726 and/or the AR device 728, performs computationally intensive tasks and reduces the computer resource utilization and/or power usage of the wrist-wearable device 726 and/or the AR device 728.

In the example shown by the first XR system 700a, the HIPD 742 identifies one or more back-end tasks and front-end tasks associated with a user request to initiate an AR video call with one or more other users (represented by the avatar 704 and the digital representation of the contact 706) and distributes instructions to cause the performance of the one or more back-end tasks and front-end tasks. In particular, the HIPD 742 performs back-end tasks for processing and/or rendering image data (and other data) associated with the AR video call and provides operational data associated with the performed back-end tasks to the AR device 728 such that the AR device 728 performs front-end tasks for presenting the AR video call (e.g., presenting the avatar 704 and the digital representation of the contact 706).

In some embodiments, the HIPD 742 can operate as a focal or anchor point for causing the presentation of information. This allows the user 702 to be generally aware of where information is presented. For example, as shown in the first XR system 700a, the avatar 704 and the digital representation of the contact 706 are presented above the HIPD 742. In particular, the HIPD 742 and the AR device 728 operate in conjunction to determine a location for presenting the avatar 704 and the digital representation of the contact 706. In some embodiments, information can be presented within a predetermined distance from the HIPD 742 (e.g., within five meters). For example, as shown in the first XR system 700a, virtual object 708 is presented on the desk some distance from the HIPD 742. Similar to the above example, the HIPD 742 and the AR device 728 can operate in conjunction to determine a location for presenting the virtual object 708. Alternatively, in some embodiments, presentation of information is not bound by the HIPD 742. More specifically, the avatar 704, the digital representation of the contact 706, and the virtual object 708 do not have to be presented within a predetermined distance of the HIPD 742. While an AR device 728 is described working with an HIPD, an MR headset can be interacted with in the same way as the AR device 728.

User inputs provided at the wrist-wearable device 726, the AR device 728, and/or the HIPD 742 are coordinated such that the user can use any device to initiate, continue, and/or complete an operation. For example, the user 702 can provide a user input to the AR device 728 to cause the AR device 728 to present the virtual object 708 and, while the virtual object 708 is presented by the AR device 728, the user 702 can provide one or more hand gestures via the wrist-wearable device 726 to interact and/or manipulate the virtual object 708. While an AR device 728 is described working with a wrist-wearable device 726, an MR headset can be interacted with in the same way as the AR device 728.

### Integration of Artificial Intelligence With XR Systems

FIG. 7A illustrates an interaction in which an artificially intelligent virtual assistant can assist in requests made by a user 702. The AI virtual assistant can be used to complete open-ended requests made through natural language inputs by a user 702. For example, in FIG. 7A the user 702 makes an audible request 744 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 7A also illustrates an example neural network 752 used in Artificial Intelligence applications. Uses of Artificial Intelligence (AI) are varied and encompass many different aspects of the devices and systems described herein. AI capabilities cover a diverse range of applications and deepen interactions between the user 702 and user devices (e.g., the AR device 728, an MR device 732, the HIPD 742, the wrist-wearable device 726). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user's request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 702 can interact with an AI model through natural language inputs captured by a voice sensor, text inputs, or any other input modality that accepts natural language and/or a corresponding voice sensor module. In another instance, input is provided by tracking the eye gaze of a user 702 via a gaze tracker module. Additionally, the AI model can also receive inputs beyond those supplied by a user 702. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors'data can be retrieved entirely from a single device (e.g., AR device 728) or from multiple devices that are in communication with each other (e.g., a system that includes at least two of an AR device 728, an MR device 732, the HIPD 742, the wrist-wearable device 726, etc.). The AI model can also access additional information (e.g., one or more servers 730, the computers 740, the mobile devices 750, and/or other electronic devices) via a network 725.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 728, an MR device 732, the HIPD 742, the wrist-wearable device 726) via the one or more networks. The cloud-computing platforms provide scalable computing resources, distributed computing, managed AI services, interference acceleration, pre-trained models, APIs and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 728, an MR device 732, the HIPD 742, the wrist-wearable device 726), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 742), haptic feedback can provide information to the user 702. An AI model can also use the inputs described above to determine the appropriate modality and device(s) to present content to the user (e.g., a user walking on a busy road can be presented with an audio output instead of a visual output to avoid distracting the user 702).

### Example Augmented Reality Interaction

FIG. 7B shows the user 702 wearing the wrist-wearable device 726 and the AR device 728 and holding the HIPD 742. In the second XR system 700b, the wrist-wearable device 726, the AR device 728, and/or the HIPD 742 are used to receive and/or provide one or more messages to a contact of the user 702. In particular, the wrist-wearable device 726, the AR device 728, and/or the HIPD 742 detect and coordinate one or more user inputs to initiate a messaging application and prepare a response to a received message via the messaging application.

In some embodiments, the user 702 initiates, via a user input, an application on the wrist-wearable device 726, the AR device 728, and/or the HIPD 742 that causes the application to initiate on at least one device. For example, in the second XR system 700b the user 702 performs a hand gesture associated with a command for initiating a messaging application (represented by messaging user interface 712); the wrist-wearable device 726 detects the hand gesture; and, based on a determination that the user 702 is wearing the AR device 728, causes the AR device 728 to present a messaging user interface 712 of the messaging application. The AR device 728 can present the messaging user interface 712 to the user 702 via its display (e.g., as shown by user 702's field of view 710). In some embodiments, the application is initiated and can be run on the device (e.g., the wrist-wearable device 726, the AR device 728, and/or the HIPD 742) that detects the user input to initiate the application, and the device provides another device operational data to cause the presentation of the messaging application. For example, the wrist-wearable device 726 can detect the user input to initiate a messaging application, initiate and run the messaging application, and provide operational data to the AR device 728 and/or the HIPD 742 to cause presentation of the messaging application. Alternatively, the application can be initiated and run at a device other than the device that detected the user input. For example, the wrist-wearable device 726 can detect the hand gesture associated with initiating the messaging application and cause the HIPD 742 to run the messaging application and coordinate the presentation of the messaging application.

Further, the user 702 can provide a user input provided at the wrist-wearable device 726, the AR device 728, and/or the HIPD 742 to continue and/or complete an operation initiated at another device. For example, after initiating the messaging application via the wrist-wearable device 726 and while the AR device 728 presents the messaging user interface 712, the user 702 can provide an input at the HIPD 742 to prepare a response (e.g., shown by the swipe gesture performed on the HIPD 742). The user 702's gestures performed on the HIPD 742 can be provided and/or displayed on another device. For example, the user 702's swipe gestures performed on the HIPD 742 are displayed on a virtual keyboard of the messaging user interface 712 displayed by the AR device 728.

In some embodiments, the wrist-wearable device 726, the AR device 728, the HIPD 742, and/or other communicatively coupled devices can present one or more notifications to the user 702. The notification can be an indication of a new message, an incoming call, an application update, a status update, etc. The user 702 can select the notification via the wrist-wearable device 726, the AR device 728, or the HIPD 742 and cause presentation of an application or operation associated with the notification on at least one device. For example, the user 702 can receive a notification that a message was received at the wrist-wearable device 726, the AR device 728, the HIPD 742, and/or other communicatively coupled device and provide a user input at the wrist-wearable device 726, the AR device 728, and/or the HIPD 742 to review the notification, and the device detecting the user input can cause an application associated with the notification to be initiated and/or presented at the wrist-wearable device 726, the AR device 728, and/or the HIPD 742.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 728 can present to the user 702 game application data and the HIPD 742 can use a controller to provide inputs to the game. Similarly, the user 702 can use the wrist-wearable device 726 to initiate a camera of the AR device 728, and the user can use the wrist-wearable device 726, the AR device 728, and/or the HIPD 742 to manipulate the image capture (e.g., zoom in or out, apply filters) and capture image data.

While an AR device 728 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light-emitting-diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user's hand or other suitable surface (e.g., a table, whiteboard). In yet another embodiment, information may also be provided by locally dimming portions of a lens to emphasize portions of the environment in which the user's attention should be directed. Some AR devices can present AR augments either monocularly or binocularly (e.g., an AR augment can be presented at only a single display associated with a single lens as opposed presenting an AR augmented at both lenses to produce a binocular image). In some instances, an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a similar manner to an MR headset, which is described below in the proceeding sections.

### Example Mixed Reality Interaction

Turning to FIGS. 7C and 7D, the user 702 is shown wearing the wrist-wearable device 726 and an MR device 732 (e.g., a device capable of providing either an entirely VR experience or an MR experience that displays object(s) from a physical environment at a display of the device) and holding the HIPD 742. In the third XR system 700c, the wrist-wearable device 726, the MR device 732, and/or the HIPD 742 are used to interact within an MR environment, such as a VR game or other MR/VR application. While the MR device 732 presents a representation of a VR game (e.g., first MR game environment 720) to the user 702, the wrist-wearable device 726, the MR device 732, and/or the HIPD 742 detect and coordinate one or more user inputs to allow the user 702 to interact with the VR game.

In some embodiments, the user 702 can provide a user input via the wrist-wearable device 726, the MR device 732, and/or the HIPD 742 that causes an action in a corresponding MR environment. For example, the user 702 in the third XR system 700c (shown in FIG. 7C) raises the HIPD 742 to prepare for a swing in the first MR game environment 720. The MR device 732, responsive to the user 702 raising the HIPD 742, causes the MR representation of the user 722 to perform a similar action (e.g., raise a virtual object, such as a virtual sword 724). In some embodiments, each device uses respective sensor data and/or image data to detect the user input and provide an accurate representation of the user 702's motion. For example, image sensors (e.g., SLAM cameras or other cameras) of the HIPD 742 can be used to detect a position of the HIPD 742 relative to the user 702's body such that the virtual object can be positioned appropriately within the first MR game environment 720; sensor data from the wrist-wearable device 726 can be used to detect a velocity at which the user 702 raises the HIPD 742 such that the MR representation of the user 722 and the virtual sword 724 are synchronized with the user 702's movements; and image sensors of the MR device 732 can be used to represent the user 702's body, boundary conditions, or real-world objects within the first MR game environment 720.

In FIG. 7D, the user 702 performs a downward swing while holding the HIPD 742. The user 702's downward swing is detected by the wrist-wearable device 726, the MR device 732, and/or the HIPD 742 and a corresponding action is performed in the first MR game environment 720. In some embodiments, the data captured by each device is used to improve the user's experience within the MR environment. For example, sensor data of the wrist-wearable device 726 can be used to determine a speed and/or force at which the downward swing is performed and image sensors of the HIPD 742 and/or the MR device 732 can be used to determine a location of the swing and how it should be represented in the first MR game environment 720, which, in turn, can be used as inputs for the MR environment (e.g., game mechanics, which can use detected speed, force, locations, and/or aspects of the user 702's actions to classify a user's inputs (e.g., user performs a light strike, hard strike, critical strike, glancing strike, miss) or calculate an output (e.g., amount of damage)).

FIG. 7D further illustrates that a portion of the physical environment is reconstructed and displayed at a display of the MR device 732 while the MR game environment 720 is being displayed. In this instance, a reconstruction of the physical environment 746 is displayed in place of a portion of the MR game environment 720 when object(s) in the physical environment are potentially in the path of the user (e.g., a collision with the user and an object in the physical environment are likely). Thus, this example MR game environment 720 includes (i) an immersive VR portion 748 (e.g., an environment that does not have a corollary counterpart in a nearby physical environment) and (ii) a reconstruction of the physical environment 746 (e.g., table 754 and cup 756). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 726, the MR device 732, and/or the HIPD 742 are described as detecting user inputs, in some embodiments, user inputs are detected at a single device (with the single device being responsible for distributing signals to the other devices for performing the user input). For example, the HIPD 742 can operate an application for generating the first MR game environment 720 and provide the MR device 732 with corresponding data for causing the presentation of the first MR game environment 720, as well as detect the user 702's movements (while holding the HIPD 742) to cause the performance of corresponding actions within the first MR game environment 720. Additionally or alternatively, in some embodiments, operational data (e.g., sensor data, image data, application data, device data, and/or other data) of one or more devices is provided to a single device (e.g., the HIPD 742) to process the operational data and cause respective devices to perform an action associated with processed operational data.

In some embodiments, the user 702 can wear a wrist-wearable device 726, wear an MR device 732, wear smart textile-based garments 738 (e.g., wearable haptic gloves), and/or hold an HIPD 742 device. In this embodiment, the wrist-wearable device 726, the MR device 732, and/or the smart textile-based garments 738 are used to interact within an MR environment (e.g., any AR or MR system described above in reference to FIGS. 7A-7B). While the MR device 732 presents a representation of an MR game (e.g., second MR game environment 720) to the user 702, the wrist-wearable device 726, the MR device 732, and/or the smart textile-based garments 738 detect and coordinate one or more user inputs to allow the user 702 to interact with the MR environment.

In some embodiments, the user 702 can provide a user input via the wrist-wearable device 726, an HIPD 742, the MR device 732, and/or the smart textile-based garments 738 that causes an action in a corresponding MR environment. In some embodiments, each device uses respective sensor data and/or image data to detect the user input and provide an accurate representation of the user 702's motion. While four different input devices are shown (e.g., a wrist-wearable device 726, an MR device 732, an HIPD 742, and a smart textile-based garment 738) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 738) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user's experience within the MR environment. Although not shown, the smart textile-based garments 738 can be used in conjunction with an MR device and/or an HIPD 742.

### Example Head-Wearable Devices

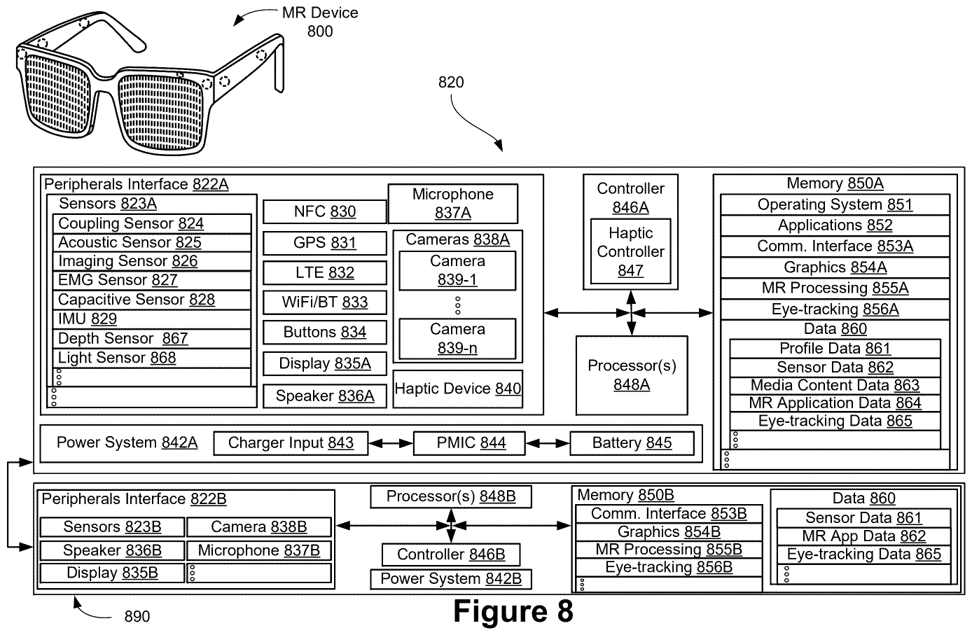

FIG. 8 shows an example head-wearable device, in accordance with some embodiments. Head-wearable devices can include, but are not limited to, MR devices 800 (e.g., AR or smart eyewear devices, such as smart glasses, smart monocles, smart contacts, etc.), VR devices (e.g., VR headsets, head-mounted displays (HMD)s, etc.), or other ocularly coupled devices. The MR devices 800 are instances of the head-wearable devices 100, 200, and 300 described in reference to FIGS. 1-3 herein, such that the head-wearable device should be understood to have the features of the MR devices 800, and vice versa. The MR devices 800 can perform various functions and/or operations associated with navigating through user interfaces and selectively opening applications, as well as the functions and/or operations described above with reference to FIGS. 1-3.

In some embodiments, the MR device 800 can include one or more analogous components (e.g., components for presenting interactive artificial-reality environments, such as processors, memory, and/or presentation devices, including one or more displays and/or one or more waveguides), some of which are described in more detail with respect to FIG. 6. The head-wearable devices can use display projectors (e.g., display projector assemblies 130-1 and 130-2 of FIG. 1) and/or waveguides for projecting representations of data to a user. Some embodiments of head-wearable devices do not include displays.

FIG. 8 illustrates a computing system 820 and an optional housing 890, each of which show components that can be included in a head-wearable device (e.g., the MR device 800). In some embodiments, more or less components can be included in the optional housing 890 depending on practical restraints of the respective head-wearable device being described. Additionally or alternatively, the optional housing 890 can include additional components to expand and/or augment the functionality of a head-wearable device.

In some embodiments, the computing system 820 and/or the optional housing 890 can include one or more peripheral interfaces 822A and 822B, one or more power systems 842A and 842B (including charger input 843, PMIC 844, and battery 845), one or more controllers 846A 846B (including one or more haptic controllers 847), one or more processors 848A and 848B (as defined above, including any of the examples provided), and memory 850A and 850B, which can all be in electronic communication with each other. For example, the one or more processors 848A and/or 848B can be configured to execute instructions stored in the memory 850A and/or 850B, which can cause a controller of the one or more controllers 846A and/or 846B to cause operations to be performed at one or more peripheral devices of the peripherals interfaces 822A and/or 822B. In some embodiments, each operation described can occur based on electrical power provided by the power system 842A and/or 842B.

For example, the peripherals interface can include one or more sensors 823A. Some example sensors include: one or more coupling sensors 824, one or more acoustic sensors 825, one or more imaging sensors 826, one or more EMG sensors 827, one or more capacitive sensors 828, and/or one or more IMUs 829. In some embodiments, the sensors 823A further include depth sensors 867, light sensors 868 and/or any other types of sensors defined above or described with respect to any other embodiments discussed herein.

In some embodiments, the peripherals interface can include one or more additional peripheral devices, including one or more NFC devices 830, one or more GPS devices 831, one or more LTE devices 832, one or more WiFi and/or Bluetooth devices 833, one or more buttons 834 (e.g., including buttons that are slidable or otherwise adjustable), one or more displays 835A, one or more speakers 836A, one or more microphones 837A, one or more cameras 838A (e.g., including the a first camera 839-1 through nth camera 839-n, which are analogous to the left camera and/or the right camera), one or more haptic devices 840; and/or any other types of peripheral devices defined above or described with respect to any other embodiments discussed herein.

The head-wearable devices can include a variety of types of visual feedback mechanisms (e.g., presentation devices). For example, display devices in the MR device 800 can include one or more liquid-crystal displays (LCDs), light emitting diode (LED) displays, organic LED (OLED) displays, micro-LEDs, and/or any other suitable types of display screens. The head-wearable devices can include a single display screen (e.g., configured to be seen by both eyes), and/or can provide separate display screens for each eye, which can allow for additional flexibility for varifocal adjustments and/or for correcting a refractive error associated with the user's vision. Some embodiments of the head-wearable devices also include optical subsystems having one or more lenses (e.g., conventional concave or convex lenses, Fresnel lenses, or adjustable liquid lenses) through which a user can view a display screen. For example, respective displays 835A can be coupled to each of the lenses 806-1 and 806-2 of the MR device 800. The displays 835A coupled to each of the lenses 806-1 and 806-2 can act together or independently to present an image or series of images to a user. In some embodiments, the MR device 800 includes a single display 835A (e.g., a near-eye display) or more than two displays 835A.

In some embodiments, a first set of one or more displays 835A can be used to present an augmented-reality environment, and a second set of one or more display devices 835A can be used to present a virtual-reality environment. In some embodiments, one or more waveguides are used in conjunction with presenting artificial-reality content to the user of the MR device 800 (e.g., as a means of delivering light from a display projector assembly and/or one or more displays 835A to the user's eyes). In some embodiments, one or more waveguides are fully or partially integrated into the MR device 800. Additionally, or alternatively to display screens, some artificial-reality systems include one or more projection systems. For example, display devices in the MR device 800 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. The head-wearable devices can also be configured with any other suitable type or form of image projection system. In some embodiments, one or more waveguides are provided additionally or alternatively to the one or more display(s) 835A.

In some embodiments of the head-wearable devices, ambient light and/or a real-world live view (e.g., a live feed of the surrounding environment that a user would normally see) can be passed through a display element of a respective head-wearable device presenting aspects of the MR system. In some embodiments, ambient light and/or the real-world live view can be passed through a portion less than all, of an MR environment presented within a user's field of view (e.g., a portion of the MR environment co-located with a physical object in the user's real-world environment that is within a designated boundary (e.g., a guardian boundary) configured to be used by the user while they are interacting with the MR environment). For example, a visual user interface element (e.g., a notification user interface element) can be presented at the head-wearable devices, and an amount of ambient light and/or the real-world live view (e.g., 15-50% of the ambient light and/or the real-world live view) can be passed through the user interface element, such that the user can distinguish at least a portion of the physical environment over which the user interface element is being displayed.

The head-wearable devices can include one or more external displays 835A for presenting information to users. For example, an external display 835A can be used to show a current battery level, network activity (e.g., connected, disconnected, etc.), current activity (e.g., playing a game, in a call, in a meeting, watching a movie, etc.), and/or other relevant information. In some embodiments, the external displays 835A can be used to communicate with others. For example, a user of the head-wearable device can cause the external displays 835A to present a do not disturb notification. The external displays 835A can also be used by the user to share any information captured by the one or more components of the peripherals interface 822A and/or generated by head-wearable device (e.g., during operation and/or performance of one or more applications).

The memory 850A can include instructions and/or data executable by one or more processors 848A (and/or processors 848B of the housing 890) and/or a memory controller of the one or more controllers 846A (and/or controller 846B of the housing 890). The memory 850A can include one or more operating systems 851; one or more applications 852; one or more communication interface modules 853A; one or more graphics modules 854A; one or more MR processing modules 855A; and/or any other types of modules or components defined above or described with respect to any other embodiments discussed herein.

The data 860 stored in memory 850A can be used in conjunction with one or more of the applications and/or programs discussed above. The data 860 can include profile data 861; sensor data 862; media content data 863; AR application data 864; eye-tracking data 865 for eye-tracking; and/or any other types of data defined above or described with respect to any other embodiments discussed herein.

In some embodiments, the controller 846A of the head-wearable devices processes information generated by the sensors 823A on the head-wearable devices and/or another component of the head-wearable devices and/or communicatively coupled with the head-wearable devices (e.g., components of the housing 890, such as components of peripherals interface 822B). For example, the controller 846A can process information from the acoustic sensors 825 and/or image sensors 826. For each detected sound, the controller 846A can perform a direction of arrival (DOA) estimation to estimate a direction from which the detected sound arrived at a head-wearable device. As one or more of the acoustic sensors 825 detects sounds, the controller 846A can populate an audio data set with the information (e.g., represented by sensor data 862).

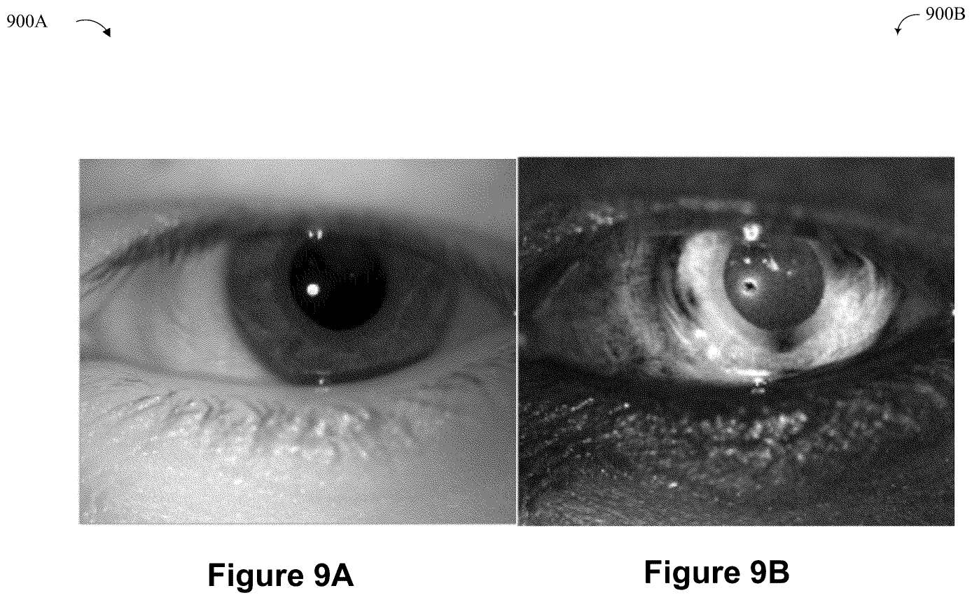

FIG. 9A shows an example camera image of an eye of a wearer of an eye-tracking system, in accordance with some embodiments. The camera image can be acquired by one or more cameras of the eye-tracking system described above with respect to FIGS. 1-4C.

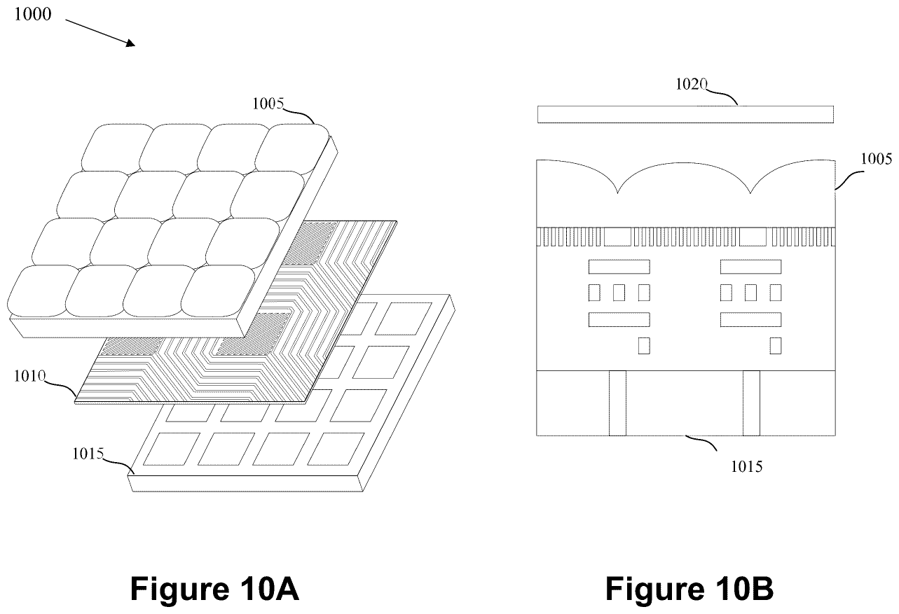

FIG. 9B shows an example polarization-sensitive image of an eye of a wearer of an eye-tracking system, in accordance with some embodiments. In some embodiments, the polarization-sensitive image is acquired by at least one camera of the one or more cameras of the eye-tracking system described above with respect to FIGS. 1-4C. For example, a nasal camera (125-1, 125-2 of FIGS. 1, 2, 4B) and/or a temporal camera (120-1, 120-2 of FIGS. 1, 3, 4A) is a polarization-sensitive camera (e.g., Sony IMX250MZR) as described below with respect to FIGS. 10A and 10B.

FIGS. 10A and 10B show example illustrations of a polarization-sensitive sensor, in accordance with some embodiments. FIG. 10A illustrates an example polarization-sensitive imaging device and/or sensor 1000 that can detect the angle and degree of polarization of light. In some embodiments, the polarization-sensitive sensor 1000 has an array of polarizers that captures the polarization state of light across an image. In some embodiments, one or more polarizers in the array of polarizers is arranged at different angles on each pixel to capture varying polarization states of light across the image. By capturing the angles and/or degree of polarization of light, the polarization-sensitive sensor 1000 can detect different material properties, enhance image contrast, and reduce glare in images.

In some embodiments, the polarization-sensitive sensor 1000 includes an on-chip lens 1005, a polarizer 1010, and a photodiode 1015. In some embodiments, the polarizer (e.g., polarizer 1010) is a four-directional polarizer that captures images showing different polarization directions of light in one shot. For example, the polarization-sensitive sensor 1000 analyzes light intensities to determine polarization directions and determine a degree of linear polarization (DoLP). In some embodiments, the polarization-sensitive sensor 1000 captures image data showing different polarization directions in real time. In some embodiments, the polarization-sensitive sensor 1000 is fabricated with semiconductor processes, and offers similar form, cost, and/or durability compared to traditional camera sensors while providing additional information about the polarization states of incident light. In some embodiments, the on-chip lens 1005 is configured to capture light over a wide field-of-view and direct the light toward the polarizer 1010 and photodiode 1015 assembly.

FIG. 10B shows an example cross-sectional illustration of the polarization-sensitive sensor, in accordance with some embodiments. In some embodiments, the polarization-sensitive sensor includes a cover glass 1020 positioned above the on-chip lens 1005 and the photodiode 1015. The cover glass 1020 can be positioned above the on-chip lens 1005 as a protection layer to improve the robustness of the sensor and protect the underlying optical components (e.g., on-chip lens 1005, polarizer, 1010, photodiode 1015) from mechanical damage.

As described above with respect to FIG. 10A, the polarization-sensitive sensor 1000 captures image data that determines the DoLP and/or angle of linear polarization (AoLP) for imaged objects. For example, the polarization-sensitive sensor 1000 captures image data that is a polarization-sensitive image for an eye of the wearer of the eye-tracking system as described above with respect to FIG. 9B. In some embodiments, the polarization-sensitive sensor 1000 captures image data that shows variations in the DoLP for the imaged eye across different eye regions (e.g., sclera, pupil, eye lid, iris, etc.).

FIGS. 11A-D show example polar orientation sclera images captured by a polarization-sensitive sensor, in accordance with some embodiments. For example, FIGS. 11A-D show example polar orientation images of collagen fibers in a sclera of an eye of the wearer of the eye-tracking system. FIG. 11A shows an example energy-weighted polar orientation image of the sclera region of the eye. FIGS. 11B-D show example close-up images of different portions of the energy-weighted polar orientation image of the sclera region of FIG. 11A. For example, FIG. 11B shows a close-up image of interweaving polar orientations of a first region 1105 (as indicated by an asterisk sign) of the sclera image of FIG. 11A. As another example, FIG. 11C shows a close-up image of circumferential polar orientations of a second region 1115 (as indicated by a ˜ sign) of the sclera image of FIG. 11A. As another example, FIG. 11D shows a close-up image of radial polar orientations of a third region 1125 (as indicated by a plus sign).

FIG. 11E shows an example polarization-sensitive image of an eye of a wearer of an eye-tracking system, in accordance with some embodiments. In some embodiments, FIG. 11E shows a first polarization-sensitive image of the eye with a first gaze direction captured by a camera (e.g., a nasal or temporal camera as described above with respect to FIGS. 1-6 positioned at a first location on a frame of a wearable device (e.g., wearable device 100 of FIG. 1)) with an eye-tracking system.

In some embodiments, FIG. 11F shows a second polarization-sensitive image of the eye with a second gaze direction captured by the camera (e.g., a nasal or temporal camera as described above with respect to FIGS. 1-6 positioned at a first location on a frame of a wearable device (e.g., wearable device 100 of FIG. 1)) with the eye-tracking system. In some embodiments, the first polarization-sensitive image and the second polarization-sensitive image are images that show the DoLP of the eye. In some embodiments, the first polarization-sensitive image and the second polarization-sensitive image are images that show the DoLP of the eye captured under uniformly polarized illumination.

In some embodiments, the DoLP images of the eye cause one or more features of the eye (e.g., collagen fiber distributions, unique collagen-related sclera patterns, etc.) to be visible (and/or trackable) that would otherwise be invisible. In some embodiments, the DoLP images of the eye are captured based on uniformly polarized illumination that is reflected by the eye toward the polarization-sensitive sensor. For example, the DoLP images of the eye are at least partially generated from sub-surface reflections of incident illumination arising from collagen networks in the eye. As another example, the DoLP images of the eye are at least partially generated from sub-surface and/or surface reflections of incident illumination arising from collagen, muscle, and/or other tissue networks in the eye. Additionally or alternatively, the DoLP images of the eye are at least partially generated based on sub-surface and/or surface diffuse reflections of incident illumination arising from collagen, muscle, eyelid(s), skin, and/or other tissue networks of the eye.

In some embodiments, the polarization information can be used to improve separation of specular and diffuse components of the light after interaction with the eye enabling improved eye-tracking capabilities even when the pupil and/or iris is not clearly visible from the point-of-view of a camera of an eye-tracking system. In some embodiments, the polarization information can be used to differentiate between back-reflected stray light and diffuse reflection from the eye that is needed for eye-tracking.

Additionally, the polarization information improves the performance of the eye-tracking system in bright light conditions (e.g., bright daylight) that could oversaturate a traditional intensity-based eye-tracking camera.

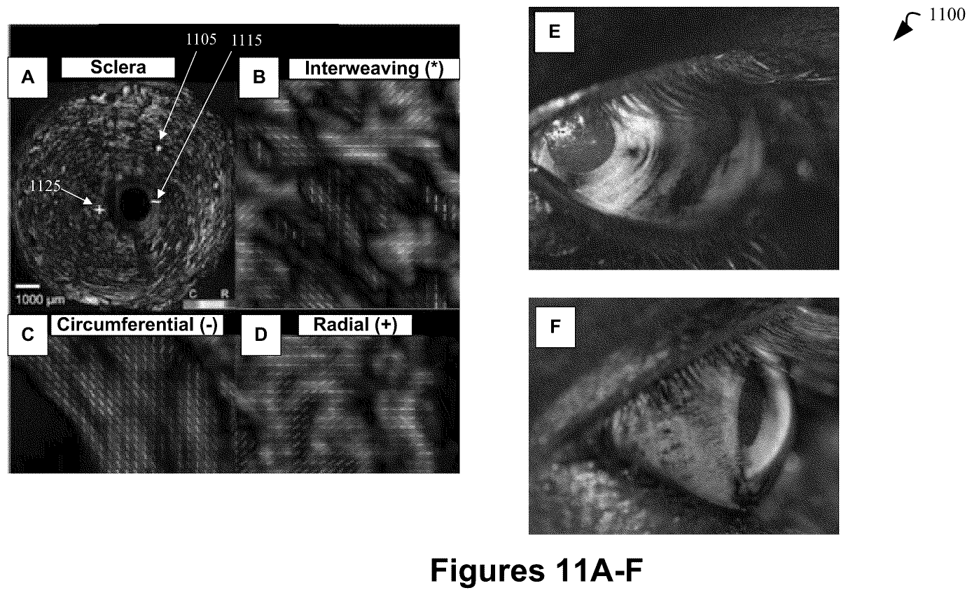

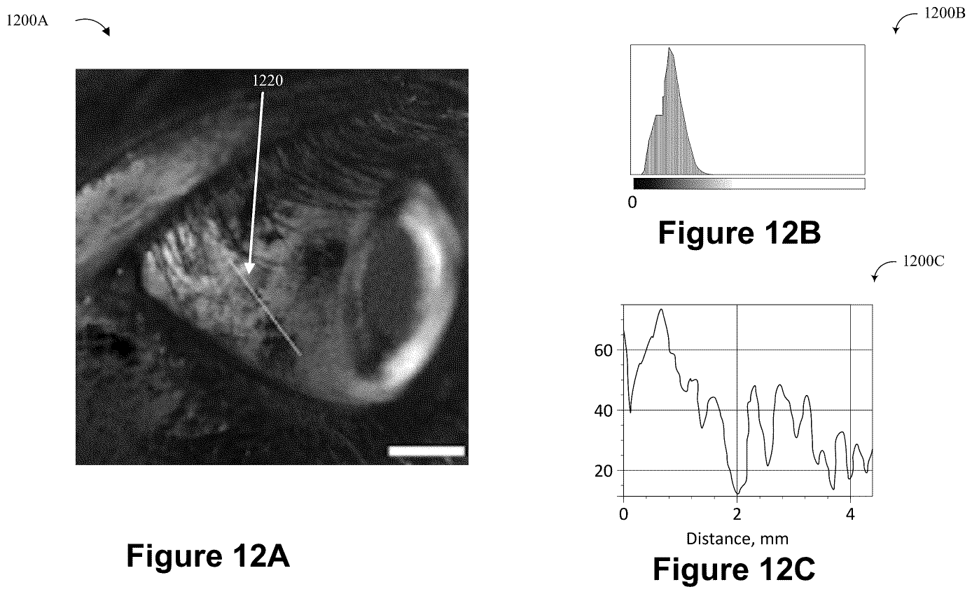

FIG. 12A shows an example polarization-sensitive image of an eye, in accordance with some embodiments. In some embodiments, the polarization-sensitive image of the eye is a DoLP image as described above with respect to FIGS. 9A-11F. In some embodiments, the DoLP image is a downsampled 200×200 pixel image. The scale bar in FIG. 12A is approximately 4 mm. FIG. 12B shows example histogram values for the DoLP distribution in the sclera region of the eye of FIG. 12A, in accordance with some embodiments. FIG. 12C shows a plot of measured DoLP values along the line 1220 in the sclera region of FIG. 12A, in accordance with some embodiments. In some embodiments, the variations in the measured DoLP values, such as along the line 1220 of FIG. 12A, provide unique DoLP distribution patterns that can be tracked to determine eye-gaze changes. For example, the measured DoLP value variations in FIG. 12C can determine one or more peak DoLP value positions in the sclera regions of the eye. The eye-tracking system can monitor changes in the positions of the one or more peak DoLP values to determine an amount of shift or change in the wearer's eye-gaze.

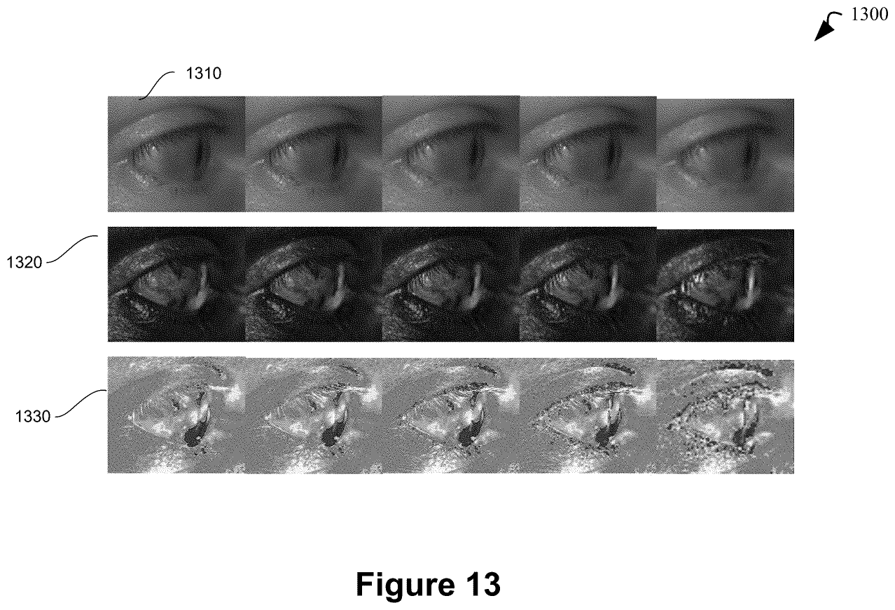

FIG. 13 shows example low resolution intensity images and corresponding low resolution DoLP and AoLP images of an eye, in accordance with some embodiments. In some embodiments, the eye-tracking system includes a low-resolution polarization-sensitive sensor that generates low resolution intensity images 1310 and corresponding low resolution DoLP images 1320 and AoLP images 1330 of the eye.

In some embodiments, there is no identifiable cliff where polarization suddenly breaks because of low resolution in the DoLP and/or AoLP images. The expected performance degradation is gradual and comparable with regular cameras. In some embodiments, a low-resolution polarization-sensitive sensor 1000 (e.g., due to a degraded on-chip lens, degraded modulation-transfer function (MTF) of the on-chip lens, etc.) does not have an impact on DoLP-and/or AoLP-related feature visibility for the captured images of the eye.

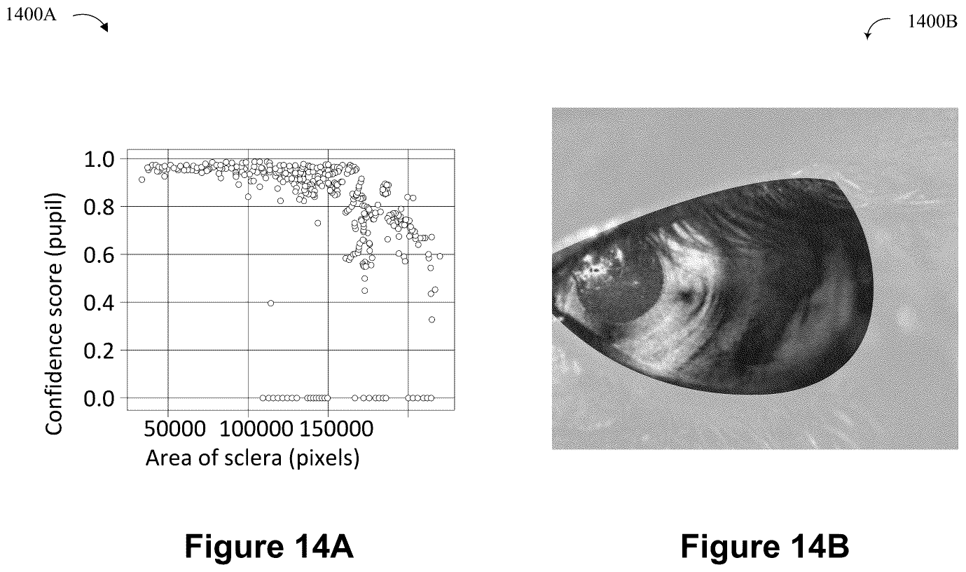

FIGS. 14A and 14B show an example illustration of variations in a confidence score versus visible imaging area of a sclera for a polarization-sensitive image of an eye, in accordance with some embodiments. FIG. 14A shows a decrease in confidence scores for accurately segmenting the pupil (e.g., for pupil detection) with traditional eye-tracking systems as the area of sclera as captured by a camera of the traditional eye-tracking system increases. FIG. 14B shows an example of an eye image as captured by a polarization-sensitive sensor (e.g., polarization-sensitive nasal camera, polarization-sensitive temporal camera) of the polarization-sensitive eye-tracking system.

In some embodiments, the visibility of the sclera, or the white part of the eye, can inversely correlate with pupil detection confidence scores because if more sclera is visible, the eye is widely open and/or looking in a direction that might partially obscure the pupil. A reduction in pupil detection confidence scores with an increase in a visible area of the sclera can make it more challenging for detection algorithms to accurately locate and/or identify the pupil, especially if the pupil is not centrally positioned within the eye. As a result, the confidence score of detecting the pupil decreases as the proportion of visible sclera increases in the traditional eye-tracking system. The polarimetric features of the eye as captured by at least one polarization-sensitive sensor of the eye-tracking system described herein will therefore have an advantageous and outsized influence for tracking the eye in otherwise challenging scenarios.

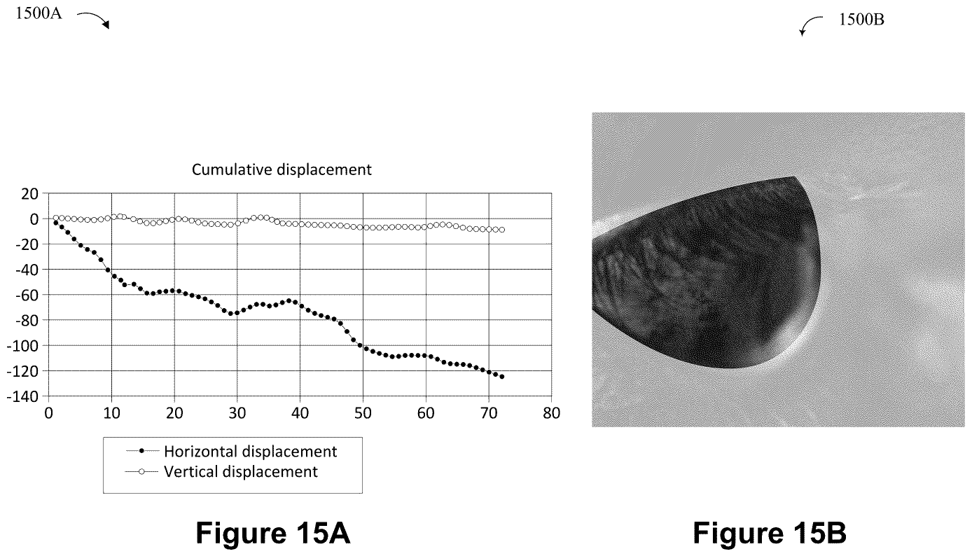

FIGS. 15A and 15B show an example illustration of variations in a cumulative displacement for optical flow measurements based on a polarization-sensitive image of the sclera region of an eye, in accordance with some embodiments. In some embodiments, a texture pattern visible on the sclera in the DoLP images, caused by birefringent collagen fiber bundles, is useful for eye tracking (and/or determining an optical flow). This unique and stable pattern provides additional contrast, allowing for easy detection and tracking of individual features that can be tracked frame to frame. As a result, analyzing the motion of this texture using optical flow enables estimation of eye movement. FIG. 15A shows cumulative eye displacements in X, Y measured in pixels that were computed using optical flow using sclera region only for the polarization-sensitive image of the eye of FIG. 15B.

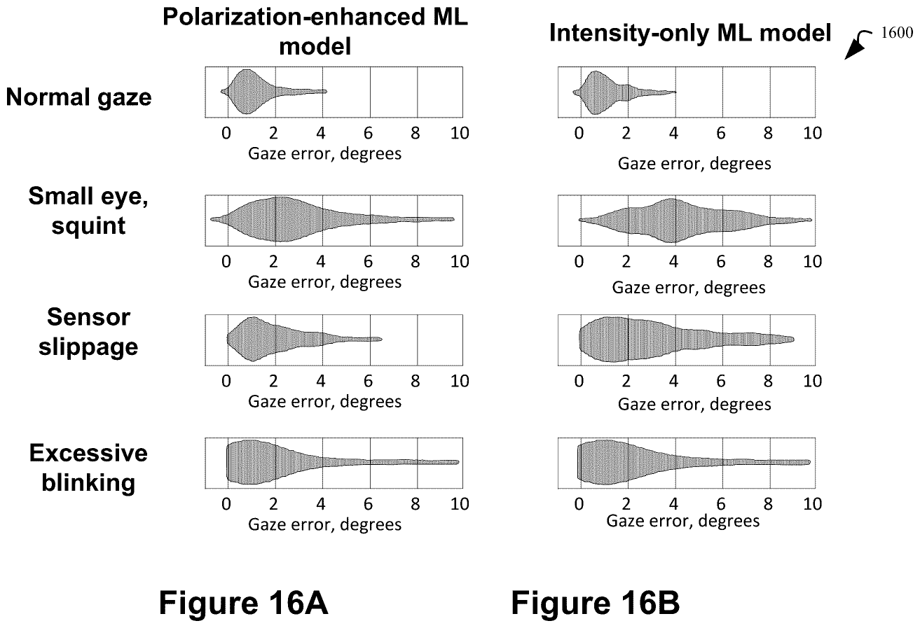

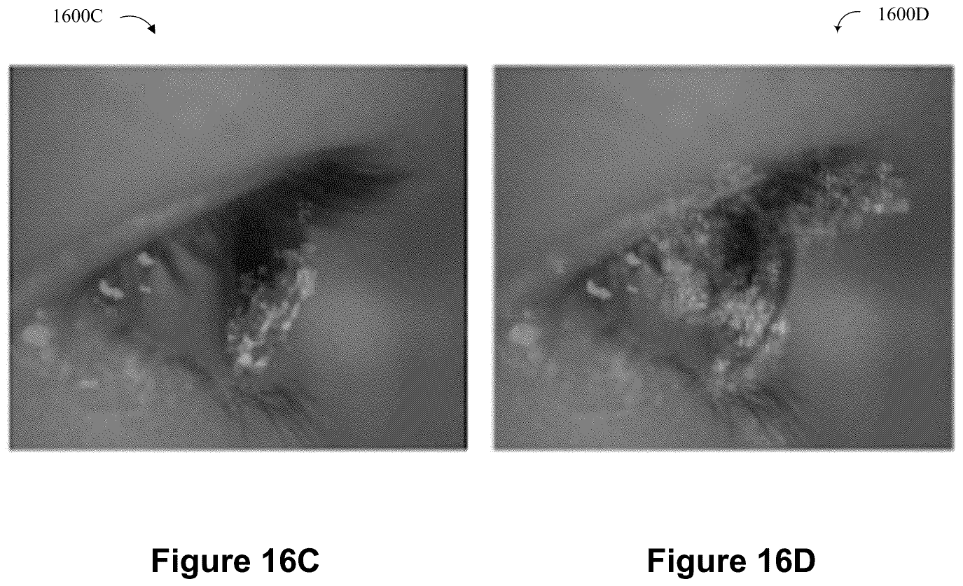

FIGS. 16A and 16B show example gaze error distributions for polarization-enhanced images and intensity-only images in varying scenarios, in accordance with some embodiments. In some embodiments, during data capture, gaze targets were presented on a screen in random order and at random locations. At least one volunteer was asked to look at the target. Over 50,000 images were captured from a single volunteer for training a machine learning model dataset. During a separate imaging session, ˜800 images were captured for a test dataset for training a convolutional neural network. For training and inference the images were downsampled to 304×256 pixels. Performance of the polarization-sensitive eye-tracking system enhanced with a machine learning model shows significant improvement with reduced gaze errors in the scenarios of squinting, sensor slippage, and excessive blinking as compared to the performance of the intensity-only machine learning model. In some embodiments, the polarization-sensitive eye-tracking system shows improved gaze error metrics in situations of pupil jitter and/or gaze jitter.

In some embodiments, consistent and significant improvement was observed in polarization-enhanced gaze prediction with a trained machine learning model and/or neural network. For example, the polarization-enhanced gaze prediction machine learning model reduces an open eye error by 31% from 1.3 deg to 0.9 deg. In some embodiments, the polarization-enhanced gaze prediction machine learning model reduces an offset error by 58% from 3.3 deg to 1.4 deg. In some embodiments, the polarization-enhanced gaze prediction machine learning model reduces errors in achieving a 95% and above accuracy by 54% from 8.3 deg to 3.8 deg. The polarization-sensitive eye-tracking system thus demonstrates high eye-tracking performance in oblique and/or off-axis placement of the one or more polarization-sensitive sensors.

FIGS. 16C and 16D show example illustrations of a polarization-enhanced image with a machine learning model and an intensity-only image with a machine learning model, in accordance with some embodiments. The machine learning model enhanced images can be referred to as saliency maps. In some embodiments, the saliency maps highlight the regions in the input image that have the most influence on the model's prediction. In some embodiments, the saliency maps provide a visual representation of which parts of the eye image the machine learning model (and/or artificial intelligence model, neural network model, etc.) focuses on when determining gaze coordinates. In some embodiments, the saliency maps provide insights and/or information about the machine learning model's decision-making process and can determine whether the machine learning model is focusing on expected and/or relevant features of the eye to predict gaze direction. In some embodiments, the maps indicate that models trained on intensity use both eye and surrounding skin for making predictions, while polarization-enhanced models are more reliant on the eye surfaces and/or sub-surface features.

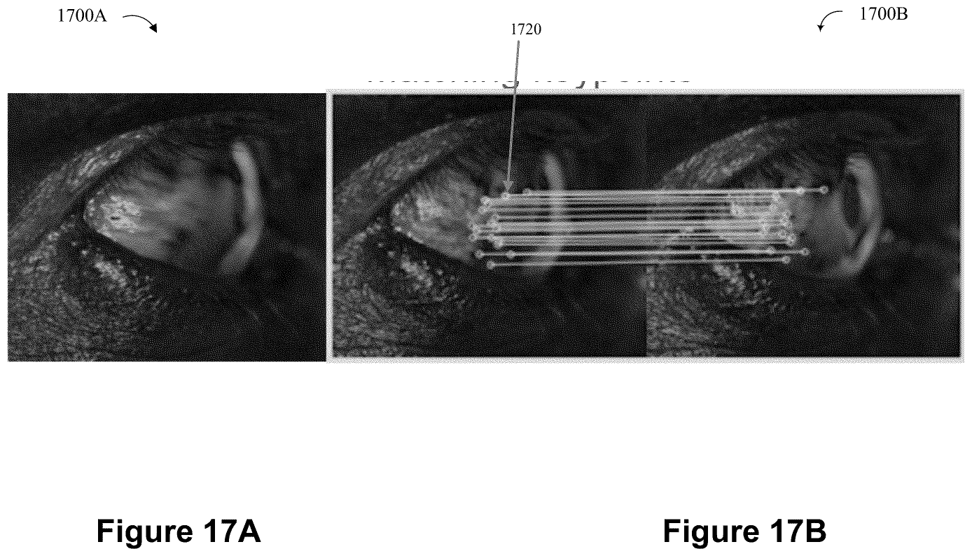

FIGS. 17A and 17B show example illustrations of sclera pattern matching in polarization-sensitive images of an eye, in accordance with some embodiments. In some embodiments, geometrically verified sclera pattern matching key points 1720 can be identified in one or more DoLP image pairs with different gaze directions. In some embodiments, the DoLP images are captured under polarized illumination. Alternatively or additionally, in some embodiments, one or more of the DoLP images are captured under non-polarized illumination.

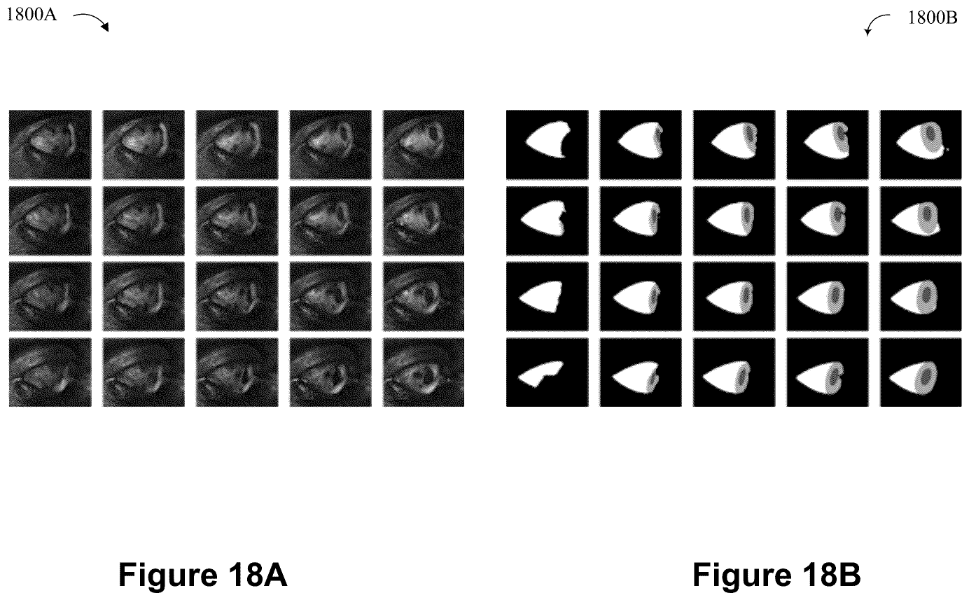

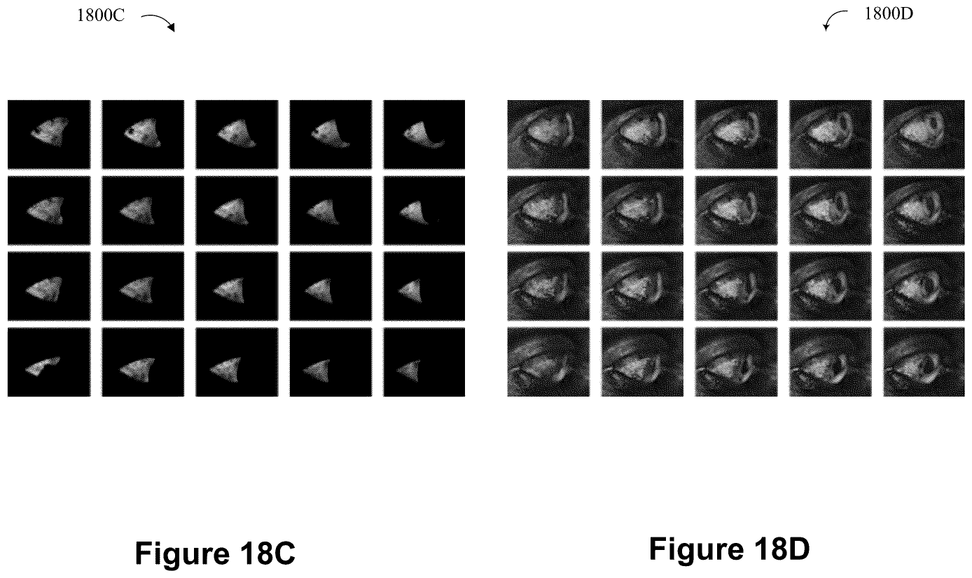

FIGS. 18A-D show example DoLP eye images, corresponding eye region mask images, masked DoLP sclera images, and DoLP images with detected sclera patterns, in accordance with some embodiments. For example, FIGS. 18A-D show visualization of DoLP scleral masks and pattern matching key points at different gaze directions. FIG. 18A shows DoLP eye images of a human subject looking at gaze targets evenly distributed on a 4-row, 5-column grid. FIG. 18B shows corresponding eye region masks generated by a pretrained in-house segmentation model (Omnieye-segformer). FIG. 18C shows masked DoLP sclera images, which show the area where the pattern matching features were calculated. FIG. 18D shows DoLP images with detected scleral pattern matching key points as described with respect to FIG. 17B above. In some embodiments, the pattern matching key points are used later in determining gaze directions and/or reconstruction of sclera structure from eye motion.

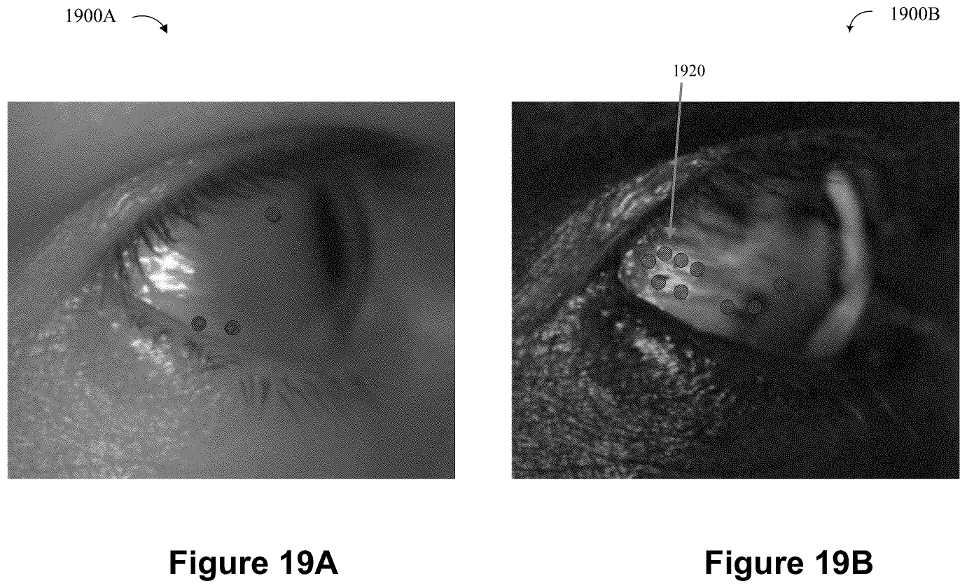

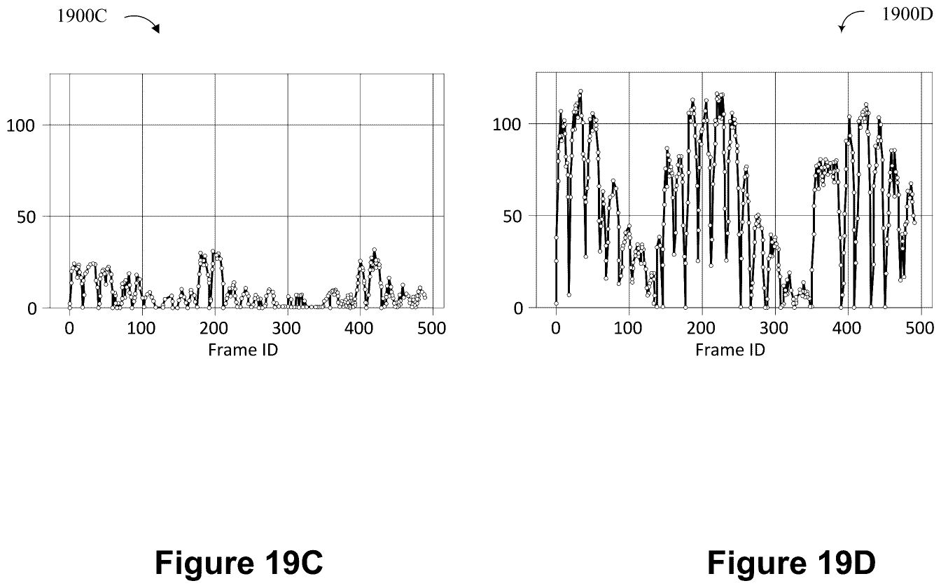

FIGS. 19A and 19B show an example intensity eye image and a corresponding DoLP image, in accordance with some embodiments. In some embodiments, FIGS. 19A and 19B show comparison images of a traditional intensity image and a DoLP image of the eye. The DoLP image of FIG. 19B shows far more visible patterns 1920 (annotated as patterned circles) in the sclera region that can be used for eye-tracking purposes as compared to the intensity eye image of FIG. 19A that fails to show more than a couple of distinguishable sclera key points (annotated as patterned circles). FIGS. 19C and 19D show the number of key points per frame that respectively correspond to the key points shown in FIGS. 19A and 19B.

In some embodiments, the eye tracking system enables world-locked rendering by using eye tracking data to correct for binocular depth perception errors and binocular planar errors. By determining the position and orientation of each eye, the system can adjust the rendered virtual content to maintain proper alignment with the real world, ensuring that virtual objects appear stable and correctly positioned in three-dimensional space.

In some embodiments, the system corrects for vertical disparity by using eye tracking to compensate for induced vertical binocular disparity. This correction improves visual comfort and reduces eye strain by ensuring that the images presented to the left and right eyes maintain proper vertical alignment.

In some embodiments, the disparity sensor system requires displaying calibration patterns on the display, which could be visible and distracting to the user. By detecting when the user's eyes are closed or blinking, the system can strategically display these calibration patterns during blinks, effectively hiding them from the user's perception. In some embodiments, the calibration patterns are displayed as the eye is closing during the initial phase of a blink and as the eye is initially opening during the final phase of a blink, making the patterns less noticeable to the user while still maintaining calibration functionality. The blink state is generated as an output from the machine learning models used for gaze and pupil tracking.

In some embodiments, the eye tracking cameras support don/doff detection by determining whether an eye is present in the eye box. This capability allows the system to detect when the glasses are being worn (donned) or removed (doffed), enabling automatic power management and user interface adjustments.

In some embodiments, The system further provides user authentication capabilities, allowing users to enroll and authenticate their device via iris recognition user authentication. The eye tracking cameras capture high-resolution images of the eye region, including the iris and features around the iris or eye. These biometric features are processed to verify the user's identity, providing secure access to the device (e.g., head-wearable headset or smart glasses) and personalized settings. When gaze or pupil tracking is already running, the images in that process can also be used for authentication purposes. In some embodiments, the authentication is performed on-device (e.g., via a machine learning model running on the head-wearable device or smart glasses).

In some embodiments, the eye tracking system aids in the alignment and fit adjustment of the glasses to the user The system can measure and report the user's interpupillary distance (IPD) to the system, enabling automatic or guided adjustments to optimize the optical alignment. The system can also provide feedback regarding optical center (OC) height and nose bridge modifications to improve fit and comfort. These fit adjustment features are particularly useful during the out-of-box experience (OOBE), helping users achieve optimal device configuration from their first use. In some embodiments, the system provides adjustment information to improve the fit and comfort of the head-wearable device or smart glasses.

In some embodiments, for social presence applications, the eye tracking system provides realistic representation of the user in virtual environments. The system tracks the upper face, including detailed eye movements and eyebrow tracking, to create realistic avatars that represent the user's facial expressions and gaze direction. For stylized avatars, the gaze tracking data controls the avatar's eye movements, so that the avatar's gaze direction matches the user's actual gaze, thereby enhancing social interactions in virtual and mixed reality environments.

In some embodiments, the eye tracking system provides gaze-based input capabilities, allowing users to target user interface affordances with their gaze. Users can direct their gaze toward virtual buttons, menus, or other interactive elements, with the system detecting the user's point of regard to enable selection and interaction. This gaze-based targeting provides a fast and intuitive input method that is particularly well-suited to augmented reality applications where traditional input devices may be cumbersome or unavailable.

In some embodiments, the eye tracking system supports contextual artificial intelligence applications by providing gaze-on-world data. The system can determine what objects or regions in the real world the user is looking at, enabling object and intent disambiguation. By understanding where the user is directing their attention, the contextual AI system can provide relevant information, suggestions, or actions based on the user's focus of attention. This capability enhances the augmented reality experience by making the system more responsive and contextually aware of the user's interests and intentions.

Some definitions of devices and components that can be included in some or all of the example devices discussed are defined here for ease of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

The foregoing descriptions of FIGS. 7A-7D and FIG. 8 provided above are intended to augment the description provided in reference to FIGS. 1-6 and FIGS. 9A-19D. While terms in the following description may not be identical to terms used in the foregoing description, a person having ordinary skill in the art would understand these terms to have the same meaning.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A head-mounted display system, comprising:
a wearable frame that includes a first nasal region and a first temporal region;
a first lens mounted in the wearable frame, wherein the first lens defines a first optical axis;
one or more display engines located on the wearable frame; and
an eye-tracking system located on the wearable frame and communicatively coupled to the one or more display engines, wherein the eye-tracking system includes:
a first polarization-sensitive camera located in the first nasal region of the wearable frame; and
a second polarization-sensitive camera located in the first temporal region of the wearable frame.

2. The head-mounted display system of claim 1, wherein each of the first polarization-sensitive camera and the second polarization-sensitive camera is positioned to image one or more physical features of an eye of a wearer of the head-mounted display system.

3. The head-mounted display system of claim 2, wherein the one or more physical features of the eye of the wearer of the head-mounted display system are characterized by at least one unique pattern with birefringence.

4. The head-mounted display system of claim 1, wherein each of the first polarization-sensitive camera and the second polarization-sensitive camera is positioned to image one or more sclera features of an eye of a wearer of the head-mounted display system.

5. The head-mounted display system of claim 1, wherein each of the first polarization-sensitive camera and the second polarization-sensitive camera is characterized by a respective field-of-view (FOV) angle between 60 and 100 degrees.

6. The head-mounted display system of claim 1, wherein the first temporal region is located between 10 degrees above the first optical axis and 30 degrees below the first optical axis from a reference point on the first optical axis, and each of the first and the second polarization-sensitive camera is characterized by a respective field-of-view (FOV) angle between 75 and 85 degrees.

7. The head-mounted display system of claim 6, wherein the reference point is located at a vertex distance from the first lens.

8. The head-mounted display system of claim 1, wherein each of the first polarization-sensitive camera and the second polarization-sensitive camera is mounted at a respective angle so that a camera optical axis of a respective camera points between 20 and 30 degrees below the first optical axis of the first lens.

9. The head-mounted display system of claim 1, further comprising:
one or more light-emitting-diodes positioned on the wearable frame to provide illumination toward a pupil of a wearer of the head-mounted display system at respective angles so that at least a portion of the illumination is reflected by a retina of the wearer.

10. The head-mounted display system of claim 1, further comprising:
one or more light-emitting-diodes positioned on the wearable frame to provide illumination toward a cornea of a wearer of the head-mounted display system at respective angles so that at least a portion of the illumination is reflected by a cornea of the wearer.

11. The head-mounted display system of claim 1, further comprising:
three or more light-emitting-diodes positioned around the wearable frame defining a light-emitting-diode plane, wherein a respective light emitting diode of the three or more light-emitting-diodes is oriented to emit light in a respective direction substantially parallel to the light-emitting-diode plane.

12. The head-mounted display system of claim 1, wherein the wearable frame includes a nose bridge, the first nasal region is located adjacent to the nose bridge, the first temporal region is located away from the nose bridge, and the first nasal region and the first temporal region are mutually exclusive to each other.

13. The head-mounted display system of claim 1, wherein:
the wearable frame includes a second nasal region that is mutually exclusive to the first nasal region and a second temporal region that is distinct and separate from the first temporal region;
the eye-tracking system further includes:
a third polarization-sensitive camera located in the second nasal region of the wearable frame; and
a fourth polarization-sensitive camera located in the second temporal region of the wearable frame, wherein each of the third polarization-sensitive camera and the fourth polarization-sensitive camera is characterized by a respective FOV angle between 60 and 100 degrees.

14. The head-mounted display system of claim 13, wherein each of the third polarization-sensitive camera and the fourth polarization-sensitive camera is characterized by a respective FOV angle between 75 degrees and 85 degrees.

15. The head-mounted display system of claim 13, further comprising:
a second lens mounted in the wearable frame, wherein the second lens defines a second optical axis, wherein each of the third polarization-sensitive camera and the fourth polarization-sensitive camera is mounted at a respective angle so that a camera optical axis of a respective polarization-sensitive camera points between 20 degrees and 30 degrees below the second optical axis of the second lens.

16. An eye-tracking system for tracking gaze directions of a user, comprising:
a frame that includes a first nasal region and a first temporal region for a first eye of the user, and a second nasal region and a second temporal region for a second eye of the user;
a first camera positioned in the first nasal region;
a second camera positioned in the first temporal region;
a third camera positioned in the second nasal region; and
a fourth camera positioned in the second temporal region, wherein at least one of the first camera, the second camera, the third camera, and the fourth camera is a polarization-sensitive camera.

17. An eye-tracking system, comprising:
a frame that includes a first nasal region and a first temporal region;
a first polarization-sensitive camera located in the first nasal region of the frame;
a second polarization-sensitive camera located in the first temporal region of the frame; and
three or more light-emitting-diodes positioned around the frame defining a light-emitting-diode plane, wherein a respective light emitting diode of the three or more light-emitting-diodes is oriented to emit light in a respective direction substantially parallel to the light-emitting-diode plane.

18. The eye-tracking system of claim 17, wherein the respective light emitting diode has a center wavelength of 940 nm.

19. The eye-tracking system of claim 17, wherein a respective optical axis of the respective light emitting diode is substantially parallel to the light-emitting-diode plane.

20. The eye-tracking system of claim 17, wherein the respective light emitting diode of the three or more light-emitting-diodes is configured to emit light within a predefined cone pattern so that at least a portion of the light emitted within the predefined cone pattern impinges on an eye of a user of the eye-tracking system.
